(19) United States
(12) Patent Application Publication
(10) Pub. No.: US 2013/0002935 A1
(43) Pub. Date: Jan. 3, 2013

(54) IMAGING APPARATUS AND METHOD, RECORDING MEDIUM, AND COMPUTER PROGRAM

(75) Inventor: Ryuhei Morita, Kanagawa (JP)

(73) Assignee: SONY CORPORATION, Tokyo (JP)

(21) Appl. No.: 13/527,693

(22) Filed: Jun. 20, 2012

(30) Foreign Application Priority Data
Jun. 28, 2011 (JP) 2011-142967

(51) Int. Cl. G03B 13/36; H04N 5/232

(52) U.S. Cl. 348/348; 348/E05.045

(57) ABSTRACT

An imaging apparatus includes: a control section configured to control timing for starting accumulations by photodiodes of a plurality of distance measuring sensors, wherein the control section controls the timing for starting the accumulations by the photodiodes such that the accumulations by the photodiodes of the plurality of distance measuring sensors end at same timing.

### FIELD

The present disclosure relates to an imaging apparatus and an imaging method, a recording medium, and a computer program and, more particularly, to an imaging apparatus and an imaging method, a recording medium, and a computer program configured to supply an accurate photodiode output.

### BACKGROUND

The autofocus technique is often provided in a digital camera to make it possible to automatically photograph a subject (see, for example, JP-A-2010-117512).

In the autofocus technique, plural distance measuring sensor pairs are set in an imaging device used in a phase difference autofocus (AF) system. A distance measuring sensor includes a CCD (Charge Coupled Device) or CMOS (Complementary Metal Oxide Semiconductor) line sensor.

In the distance measuring sensor, charges corresponding to incident light are accumulated by a photodiode and the charges are stored in an analog memory until the charges are read out.

FIG. 1 is a diagram of an example of an imaging device for AF 401 in the past. The imaging device for AF 401 includes plural distance measuring sensor pairs 501-1 to 501-X (X is a natural number).

When it is unnecessary to respectively distinguish the distance measuring sensor pairs 501-1 to 501-X, the distance measuring sensor pairs 501-1 to 501-X are hereinafter simply described as distance measuring sensor pair 501. The same applies to other components in this specification.

The distance measuring sensor pair 501 executes AF control processing on a predetermined distance measuring point. The distance measuring sensor pair 501 is explained with reference to FIG. 2.

FIG. 2 is a block diagram of a configuration example of the distance measuring sensor pair 501 in the past. The distance measuring sensor pair 501 includes an imaging pixel row 521 and a monitor sensor 522.

The imaging pixel row 521 includes photodiodes 541-1 to 541-Y (Y is a natural number), a readout section 542, analog memory sections 543-1 to 543-Y, and an output section 544. One analog memory section 543 corresponds to one photodiode 541. The monitor sensor 522 includes a photodiode.

The distance measuring sensor pair 501 accumulates charges of the photodiodes 541 of the imaging pixel row 521 on the basis of time until an output of the monitor sensor 522 increases to be equal to or larger than a predetermined threshold.

After ending the accumulation of the charges of the photodiodes 541, the distance measuring sensor pair 501 causes the analog memory sections 543 to store output results of the photodiodes 541 via the readout section 542.

The output section 544 outputs the output results of the photodiodes 541 stored in the analog memory sections 543. A single lens reflex camera executes control processing for a distance measuring point on the basis of the output results of the photodiodes 541 output by the output section 544.

### SUMMARY

However, in the analog memory sections 543, as an output retention time for retaining the output results of the photodiodes 541 increases, noise components due to heat and the like increase.

For example, when the distance measuring sensor pair 501-1 accumulates charges corresponding to high-luminance light and the distance measuring sensor pair 501-2 accumulates charges corresponding to low-luminance light, i.e., when degrees of luminance for the two distance measuring sensors 501 are substantially different, there is a large difference between a charge accumulation time of the distance measuring sensor pair 501-1 and a charge accumulation time of the distance measuring sensor pair 501-2.

A relation between the accumulation times and output retention times of the distance measuring sensor pairs 501-1 and 501-2 is explained with reference to FIG. 3.

FIG. 3 is a diagram for explaining an example of accumulation times 561-1 and 561-2 and output retention times 562-1 and 562-2 of the distance measuring sensor pairs 501-1 and 502-1.

An example of accumulation and retention of charges corresponding to high-luminance light by the distance measuring sensor pair 501-1 is shown in the upper side of FIG. 3. When the photodiodes 541 of the distance measuring sensor pair 501-1 accumulate charges corresponding to high-luminance light, the accumulation time 561-1 of the charges is a relatively short time, for example, several microseconds.

On the other hand, an example of accumulation and retention of charges corresponding to low-luminance light by the distance measuring sensor pair 501-2 is shown on the lower side of FIG. 3.

When the photodiodes 541 of the distance measuring sensor pair 502-1 accumulate charges corresponding to low-luminance light, the accumulation time 561-2 of the charges is a long time compared with the accumulation time 561-1 of the distance measuring sensor pair 501-1 that accumulates charges corresponding to high-luminance light, for example, several hundred milliseconds.

In such a case, output results of the photodiodes 541 of the distance measuring sensor pair 501-1 that accumulates charges of high-luminance light are retained in the analog memory sections 543 of the distance measuring sensor pair 501-1 until accumulations by the photodiodes 541 of the distance measuring sensor pair 501-2 that accumulates charges of low-luminance light end.

As shown in FIG. 3, the output retention time 562-1 of the analog memory sections 543 of the distance measuring sensor pair 501-1 is sufficiently long with respect to the accumulation time 561-1. Therefore, noise components due to heat and the like increase and an S/N ratio is deteriorated.

Therefore, it is desirable to make it possible to supply an accurate photodiode output.

An embodiment of the present disclosure is directed to an imaging apparatus including a control section configured to control timing for starting accumulations by photodiodes of a plurality of distance measuring sensor pairs. The control section controls the timing for starting the accumulations by the photodiodes of a plurality of the distance measuring sensors such that the accumulations by the photodiodes end at the same timing.

The imaging apparatus may further include, for each of the distance measuring sensors or each of the distance measuring sensor pairs, a monitor sensor for determining an accumulation time of the photodiodes. The control section may control the timing for starting the accumulations by the photodiodes on the basis of the accumulation time determined by the monitor sensor.

When an output of the monitor sensor does not exceed a predetermined threshold within a predetermined time, the control section may start accumulations by the photodiodes of the distance measuring sensor pairs for long accumulation corresponding to the monitor sensor. The control section may control timing for starting accumulations by the photodiodes of the plurality of distance measuring sensor pairs for short accumulation such that timing for ending an accumulation by the distance measuring sensor pair for short accumulation, an output of the monitor sensor corresponding to which exceeds the predetermined threshold within the predetermined time, is time when length of time same as the predetermined time elapses from timing for starting the accumulation by the distance measuring sensor pair for long accumulation.

When all outputs of a plurality of the monitor sensors exceed the predetermined threshold within the predetermined time, the control section may start accumulations by the photodiodes of the distance measuring sensor pair, an output of the monitor sensor corresponding to which exceeds the predetermined threshold last. When the output of the monitor sensor exceeds the predetermined threshold last, the control section may control timing for starting accumulations by the photodiodes of the other distance measuring sensor pairs such that accumulations by the photodiodes of the other distance measuring sensor pairs end at the same timing as an end of accumulations by the photodiodes of the distance measuring sensor pair, the output of the monitor sensor corresponding to which exceeds the predetermined threshold last.

The imaging apparatus may further include an A/D conversion section configured to convert analog signals, which are output results of the photodiodes, into digital signals. The A/D conversion section may convert analog signals, which are output results of the photodiodes of the plurality of distance measuring sensors, into digital signals at the same timing.

The imaging apparatus may further include one reference-signal generating section. The A/D conversion section may convert the analog signals, which are the output results of the photodiodes, into digital signals using a reference voltage of the reference-signal generating section.

The A/D conversion section may convert the analog signals, which are the output results of the photodiodes, into digital signals in a column ADC system using the reference voltage of the reference-signal generating section.

The imaging apparatus may further include a digital memory section configured to store the output results of the photodiodes converted into the digital signals by the A/D conversion section.

Another embodiment of the present disclosure is directed to an imaging method including controlling timing for starting accumulations by photodiodes of a plurality of distance measuring sensors. The controlling the timing includes controlling the timing for starting the accumulations by the photodiodes of the plurality of distance measuring sensors such that the accumulations by the photodiodes end at the same timing.

Still another embodiment of the present disclosure is directed to a computer program or a computer-readable recording medium having stored therein a computer program for causing a computer to control timing for starting accumulations by photodiodes of a plurality of distance measuring sensors. The controlling the timing includes controlling the timing for starting the accumulations by the photodiodes of the plurality of distance measuring sensors such that the accumulations by the photodiodes end at the same timing.

In the embodiments, timing for starting accumulations by the photodiodes of the plurality of distance measuring sensors is controlled such that the accumulations by the photodiodes end at the same timing.

According to the embodiments of the present disclosure, it is possible to supply an accurate photodiode output.

### BRIEF DESCRIPTION OF THE DRAWINGS

FIG. 1 is a block diagram of the configuration of an imaging device for AF in the past;

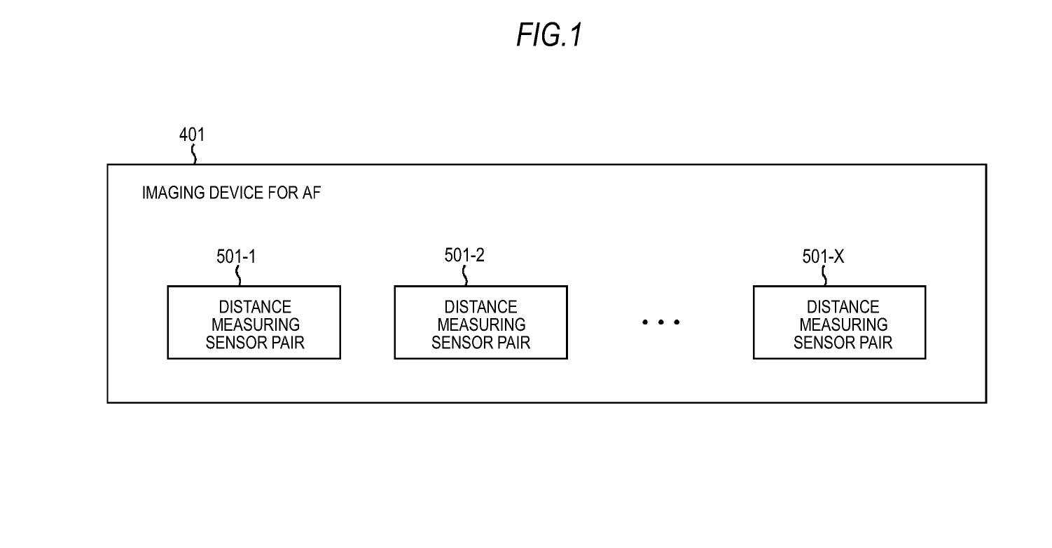

FIG. 2 is a block diagram of the configuration of a distance measuring sensor pair in the past;

FIG. 3 is a diagram for explaining an example of an accumulation by the imaging device for AF in the past;

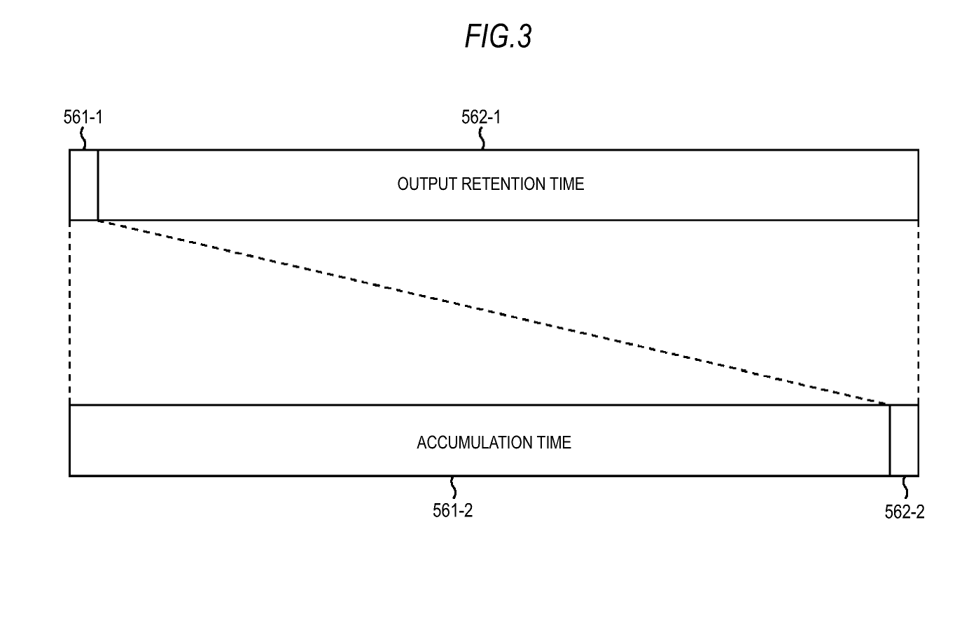

FIG. 4 is a block diagram of a configuration example of a single lens reflex camera according to an embodiment of the present disclosure;

FIG. 5 is a block diagram of a functional configuration example of a CPU;

FIGS. 6A and 6B are diagrams of simple arrangement examples of the single lens reflex camera;

FIG. 7 is a diagram of an arrangement example of distance measuring sensor pairs;

FIG. 8 is a diagram of an example of distance measuring points;

FIG. 9 is a block diagram of the configuration of an imaging device for AF according to the embodiment;

FIG. 10 is a block diagram of the configuration of a sensor row according to the embodiment;

FIG. 11 a diagram of an example of a readout section;

FIG. 12 is a diagram of an example of accumulations by the distance measuring sensor pairs;

FIGS. 13A to 13C are diagrams of examples of outputs of the distance measuring sensor pairs;

FIG. 14 is a diagram of an arrangement example of the distance measuring sensor pairs;

FIG. 15 is a diagram for explaining the size of reference-signal generating sections;

FIG. 16 is a flowchart for explaining distance measuring sensor accumulation processing;

FIG. 17 is a timing chart of an example of accumulations by the distance measuring sensor pairs;

FIG. 18 is a flowchart for explaining long accumulation processing;

FIG. 19 is a flowchart for explaining short accumulation processing;

FIG. 20 is a timing chart of accumulations and outputs by the distance measuring sensor pairs;

FIG. 21 is a flowchart for explaining distance measuring sensor accumulation processing;

FIG. 22 is a timing chart of an example of an accumulation by a short accumulation distance measuring sensor; and

FIG. 23 is a flowchart for explaining short accumulation processing.

### DETAILED DESCRIPTION

Exemplary embodiments of the present disclosure are explained below. The explanation is made in the order described below.

1. Configuration of a single lens reflex camera

2. Configuration of an imaging device for AF

3. Distance measuring sensor accumulation processing 1

4. Long accumulation processing

5. Short accumulation processing 1

6. Distance measuring sensor accumulation processing 2

7. Short accumulation processing 2

8. Others

### [Configuration of a Single Lens Reflex Camera]

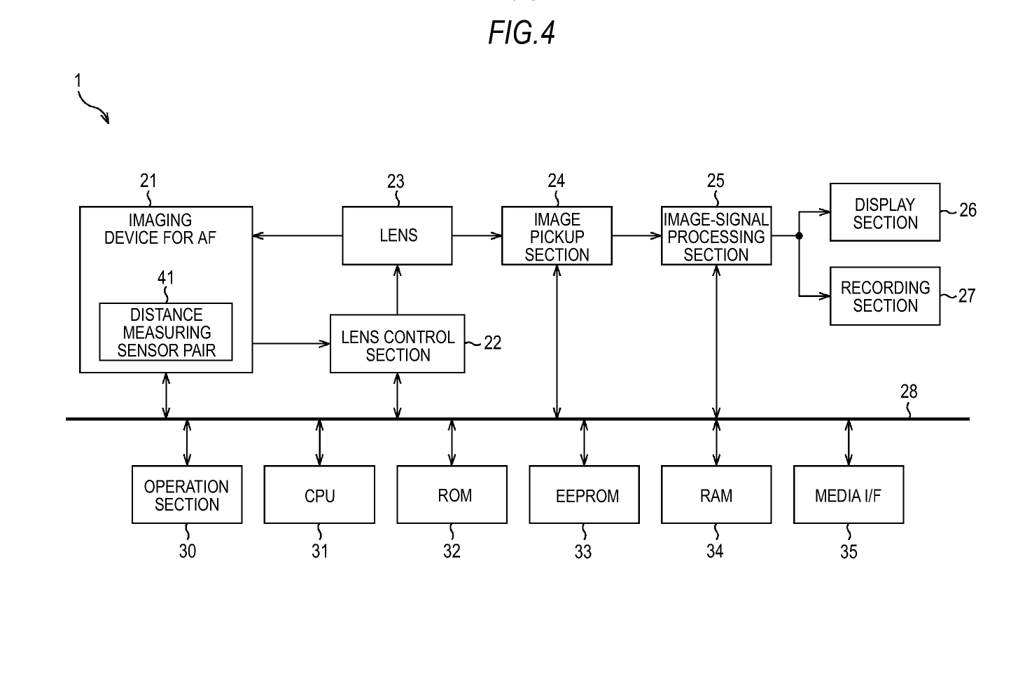

FIG. 4 is a block diagram of a configuration example of a single lens reflex camera 1 to which the present disclosure is applied.

The single lens reflex camera 1 functioning as an imaging apparatus includes an imaging device for AF 21, a lens control section 22, a lens 23, an image pickup section 24, an image-signal processing section 25, a display section 26, a recording section 27, a bus 28, an operation section 30, a CPU (Central Processing Unit) 31, a ROM (Read Only Memory) 32, an EEPROM (Electrically Erasable Programmable ROM) 33, a RAM (Random Access Memory) 34, and a media I/F (Interface) 35.

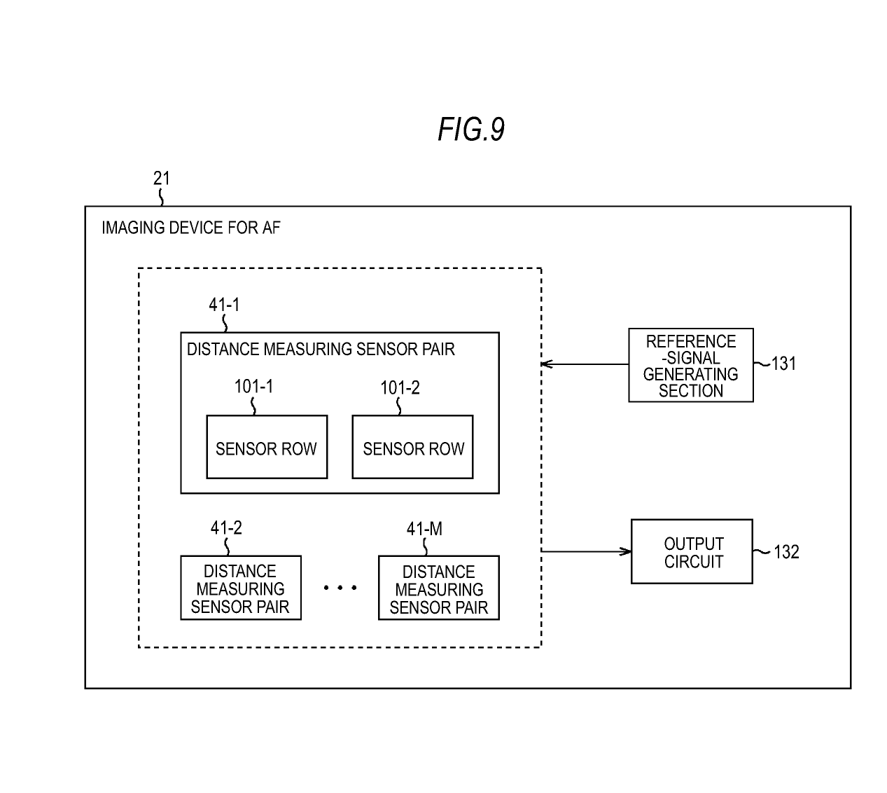

The imaging device for AF 21 includes a distance measuring sensor pair 41 including photodiodes. Details of the imaging device for AF 21 are explained below with reference to FIG. 9. The lens control section 22 controls a focus position of the lens 23 on the basis of an output result from the imaging device for AF 21.

The lens 23 includes a convex lens and absorbs light from a subject. The image pickup section 24 picks up an image of the subject via the lens 23.

The image pickup section 24 includes a CCD image sensor or a CMOS image sensor.

The image-signal processing section 25 converts an analog video signal of a picked-up still image of the subject into a digital video signal. The display section 26 includes a liquid crystal display and displays an image corresponding to the digital video signal acquired from the image-signal processing section 25.

The recording section 27 records the digital video signal acquired from the image-signal processing section 25.

The bus 28 connects the imaging device for AF 21, the lens control section 22, the image pickup section 24, the image-signal processing section 25, the operation section 30, the CPU 31, the ROM 32, the EEPROM 33, the RAM 34, and the media I/F 35 to one another.

The operation section 30 receives an input from a user. The operation section 30 includes buttons, switches, and a touch panel display.

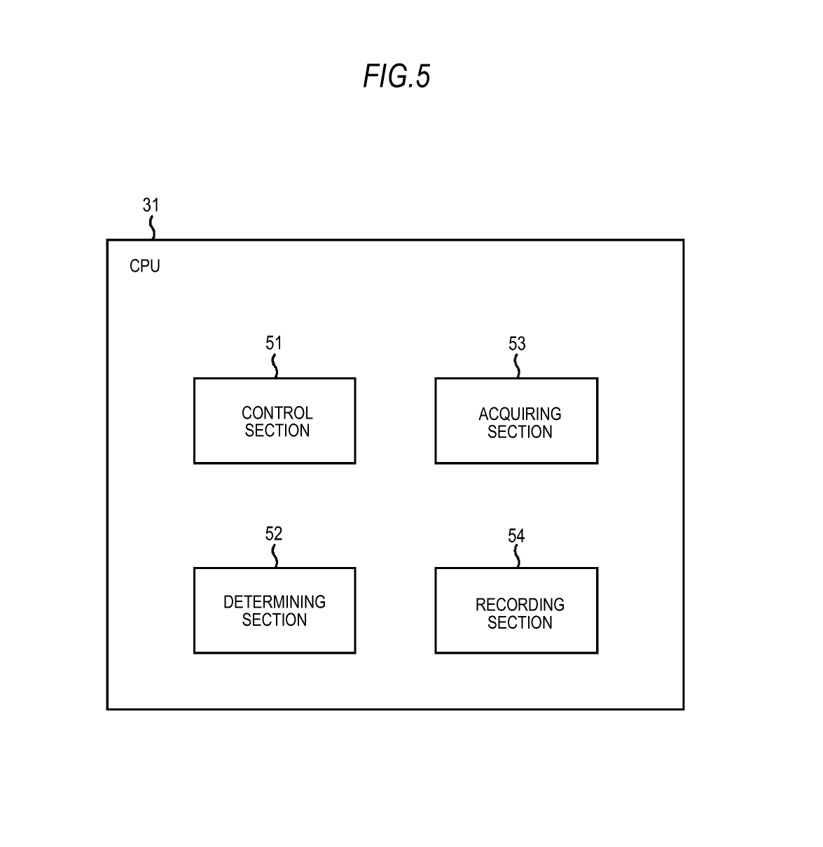

The CPU 31 controls the operation of the single lens reflex camera 1. A microcomputer can be used instead of the CPU 31. Details of the CPU 31 are explained with reference to FIG. 5.

FIG. 5 is a block diagram of a functional configuration example of the CPU 31.

The CPU 31 includes functional blocks of a control section 51, a determining section 52, an acquiring section 53, and a recording section 54. The blocks of the CPU 31 are enabled to exchange signals and data with one another according to necessity.

The control section 51 controls various kinds of information. The determining section 52 executes various kinds of determination processing. The acquiring section 53 acquires the various kinds of information. The recording section 54 records the various kinds of information.

The functional blocks of the control section 51, the determining section 52, the acquiring section 53, and the recording section 54 may be provided in the lens control section 22.

Referring back to FIG. 4, the ROM 32 records various processing programs executed in the single lens reflex camera 1 and data and the like necessary for processing. The EEPROM 33 is a nonvolatile memory and records information that needs to be retained even after power-off such as setting of the single lens reflex camera 1 input by the user.

The RAM 34 is used as a work area for various kinds of processing to, for example, temporarily record and retain data obtained in the various kinds of processing. The media I/F 35 is an interface mutually connected to a removable disk such as a recording medium and a personal computer.

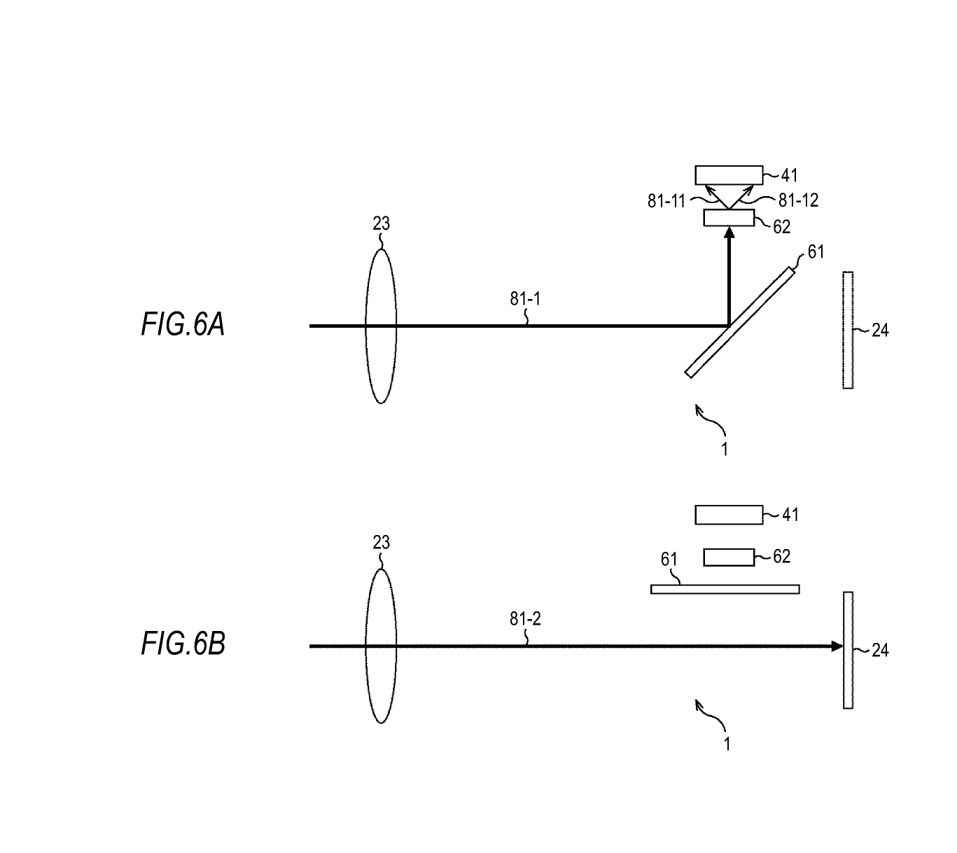

FIGS. 6A and 6B are diagrams of a simple arrangement example in the single lens reflex camera 1. In the example shown in FIGS. 6A and 6B, the lens 23, the image pickup section 24, the distance measuring sensor pair 41, a mirror 61, and a separator lens 62 are shown.

The mirror 61 operates to reflect light made incident via the lens 23 and make the light incident on the distance measuring sensor pair 41. The separator lens 62 including a convex lens divides the incident light into two or more plural lights and irradiates the lights on the distance measuring sensor pair 41.

FIG. 6A is a diagram of a state during an AF operation. As shown in FIG. 6A, during the AF operation, one end of the mirror 61 is arranged in a position moved downward such that light 81-1 made incident via the lens 23 is reflected on the mirror 61 and made incident on the distance measuring sensor pair 41.

The light 81-1 reflected by the mirror 61 is divided into light 81-11 and light 81-12 via the separator lens 62, which are respectively made incident on the distance measuring sensor pair 41.

The distance measuring sensor pair 41 applies AF control processing of a phase difference detection system or the like to the incident lights 81-11, 81-12, to thereby detect deviation of two focusing positions.

FIG. 6B is a diagram of a state during image pickup. As shown in FIG. 6B, during the image pickup, the mirror 61 is flipped up such that light 81-2 made incident via the lens 23 is made incident on the image pickup section 24. Therefore, during the image pickup, light is not made incident on the distance measuring sensor pair 41.

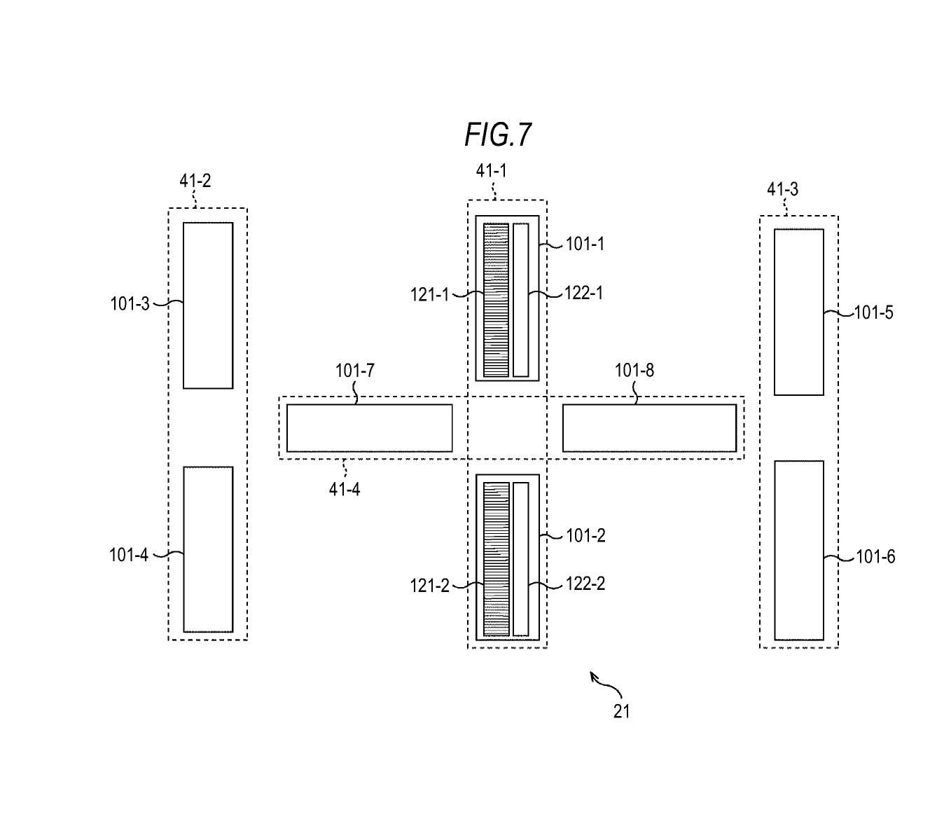

FIG. 7 is a diagram of an example of the imaging device for AF 21 in the phase difference detection system.

In the imaging device for AF 21 shown in FIG. 7, four distance measuring sensor pairs 41-1 to 41-4 are shown. One distance measuring sensor pair 41 includes a pair of two sensor rows. For example, the distance measuring sensor pair 41-1 includes a sensor row 101-1 and a sensor row 101-2.

A sensor row 101 includes an imaging pixel row 121 and a monitor sensor 122. For example, the sensor row 101-1 includes an imaging pixel row 121-1 and a monitor sensor 122-1 and the sensor row 101-2 includes an imaging pixel row 121-2 and a monitor sensor 122-2.

In FIG. 7, only the imaging pixel rows 121-1 and 121-2 and the monitor sensors 122-1 and 122-2 of the sensor rows 101-1 and 101-2 are shown. However, imaging pixel rows 121 and monitor sensors 122 are provided in the other sensor rows 101-3 to 101-8 as well.

The imaging pixel row 121 includes plural photodetectors such as photodiodes and detects light amounts of lights made incident on respective positions.

The monitor sensor 122 includes a photodetector such as a photodiode and outputs a signal of an average of outputs of the imaging pixel row 121 corresponding to the monitor sensor 122 or a signal in the same level as representative one pixel.

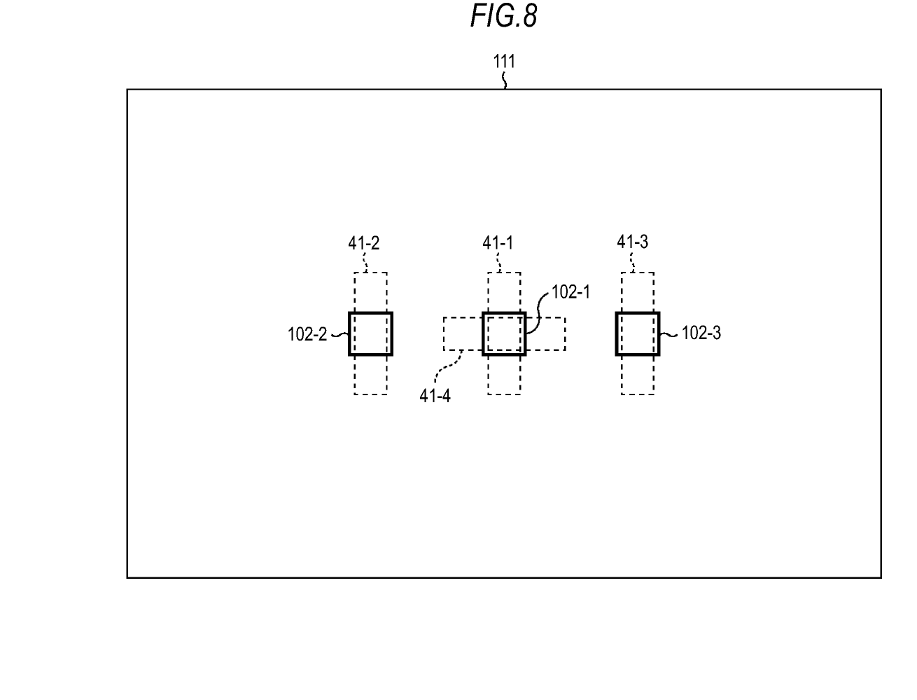

The distance measuring sensor pair 41 includes one distance measuring point. The distance measuring point is explained with reference to FIG. 8.

FIG. 8 is a diagram of an example of distance measuring points on a finder obtained by the configuration shown in FIG. 7. In the example shown in FIG. 8, three distance measuring points 102-1 to 102-3 are shown. When AF control processing is executed, any one of the three distance measuring points 102-1 to 102-3 is selected.

The distance measuring points 102-1 to 102-3 are located in substantially the centers of the distance measuring sensor pairs 41-1 to 41-3 corresponding to the distance measuring points 102-1 to 102-3 (between the sensor rows). Specifically, for example, in the distance measuring sensor pair 41-2, the distance measuring point 102-2 is located between the sensor row 101-3 and the sensor row 101-4.

When the distance measuring point 102-2 on the left side is selected, the AF control processing is executed using the distance measuring sensor pair 41-2 including the sensor rows 101-3 and 101-4.

When the distance measuring point 102-3 on the right side is selected, the AF control processing is executed using the distance measuring sensor pair 41-3 including the sensor rows 101-5 and 101-6.

In order to improve the accuracy of the AF, plural distance measuring sensors 41 may be arranged at one distance measuring point 102.

For example, when the distance measuring point 102-1 in the center is selected, the AF control processing is executed using the distance measuring sensor pair 41-1 including the sensor rows 101-1 and 101-2 and the distance measuring sensor pair 41-4 including the sensor rows 101-7 and 101-8.

### [Configuration of the Imaging Device for AF]

FIG. 9 is a block diagram of a configuration example of the imaging device for AF 21 to which the present disclosure is applied. The imaging device for AF 21 includes distance measuring sensor pairs 41-1 to 41-M (M is a natural number; in the embodiment shown in FIG. 7, M=4), a reference-signal generating section 131, and an output circuit 132.

The distance measuring sensor pair 41 includes two sensor rows 101. The distance measuring sensor pair 41 outputs information for the AF control processing, i.e., information for detecting an amount of defocusing (a phase difference) respectively from images of a subject output from the two sensor rows 101.

The reference-signal generating section 131 includes a digital analog converter (DAC) (not shown). The reference-signal generating section 131 supplies a common analog reference voltage to M distance measuring sensor pairs 41-1 to 41-M.

The distance measuring sensor pairs 41-1 to 41-M output output results to the output circuit 132. The output circuit 132 outputs output results of the M distance measuring sensor pairs 41 to the CPU 31.

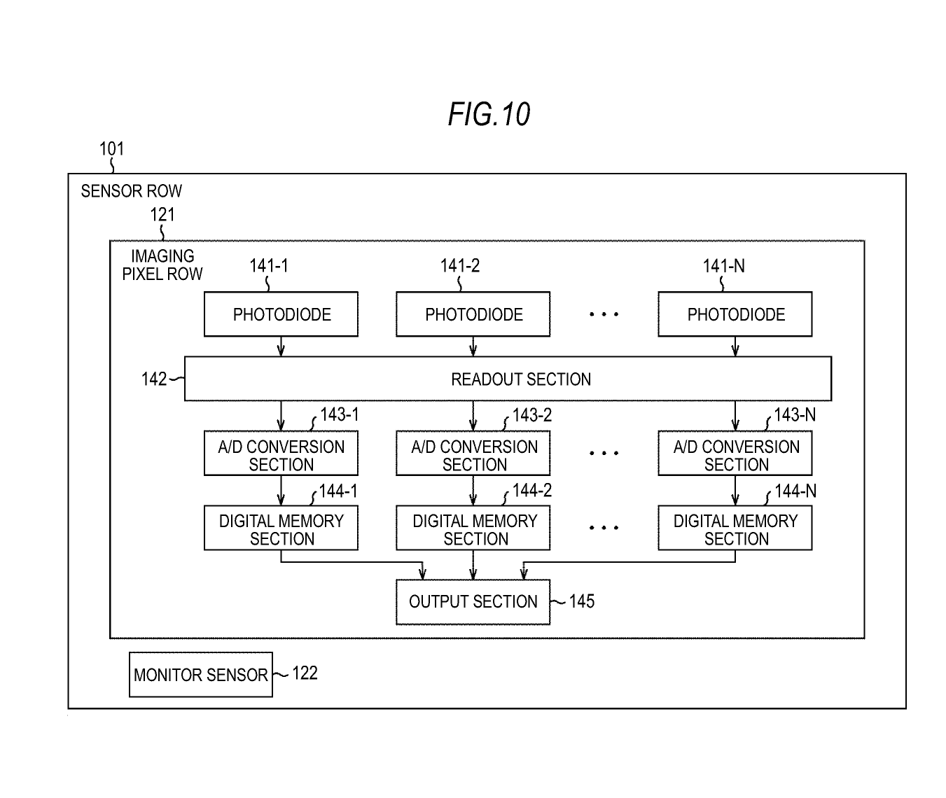

An example of the sensor row 101 is explained with reference to FIG. 10.

FIG. 10 is a block diagram of a configuration example of the sensor row 101. The sensor row 101 includes the imaging pixel row 121 and the monitor sensor 122.

The imaging pixel row 121 includes photodiodes 141-1 to 141-N (N is a natural number), a readout section 142, A/D conversion sections 143-1 to 143-N, digital memory sections 144-1 to 144-N, and an output section 145.

One A/D conversion section 143 and one digital memory section 144 correspond to one photodiode 141.

The monitor sensor 122 also includes a photodiode. The monitor sensor 122 may include one photodiode or may include two or more plural photodiodes, for example, N photodiodes corresponding to the imaging pixel rows 121.

The photodiodes 141 are arranged in a row and accumulate charges corresponding to a light amount of incident light. The photodiode of the monitor sensor 122 also accumulates charges corresponding to the incident light amount.

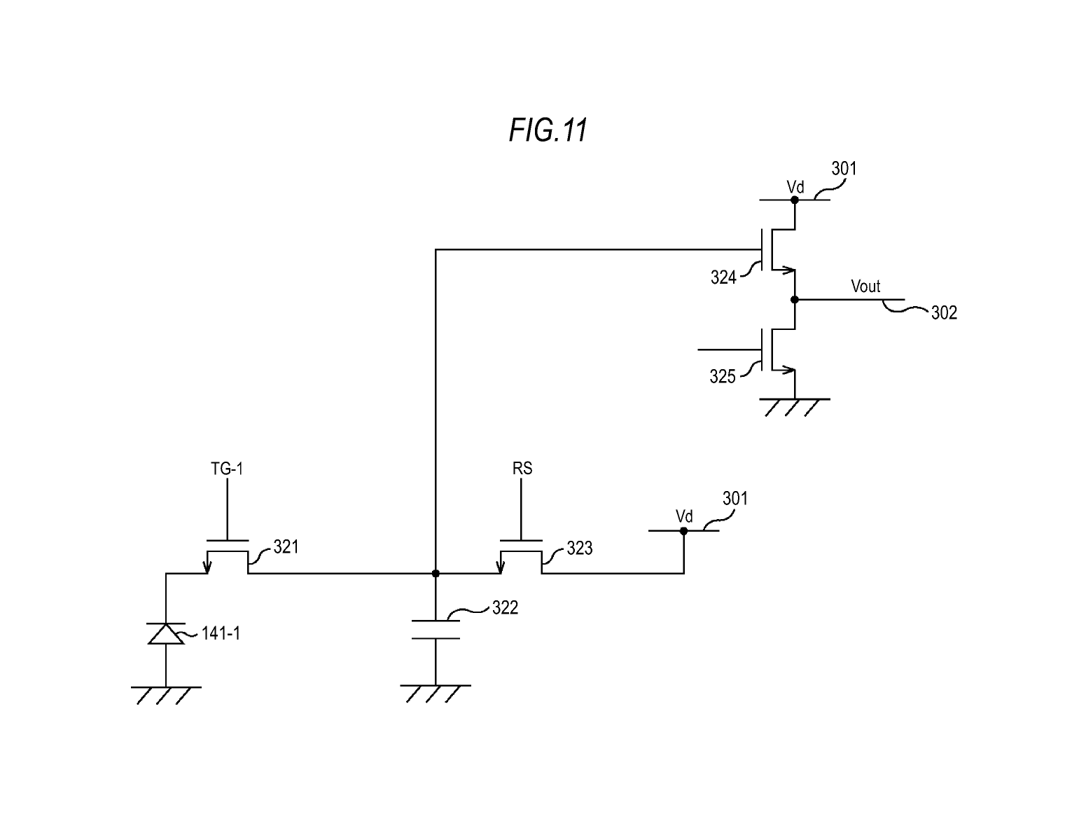

The readout section 142 reads out an output of the photodiodes 141 and outputs the read-out output to the A/D conversion sections 143 corresponding to the photodiodes 141. A circuit configuration of the readout section 142 is explained with reference to FIG. 11.

FIG. 11 is a diagram of an example of the circuit configuration of the readout section 142. In FIG. 11, a configuration for reading out a signal from one photodiode 141-1 is shown.

In the example shown in FIG. 11, a capacitor 322 to which charges of the photodiode 141-1 are transferred via a transfer gate 321 is connected to be reset by a reset gate 323 according to potential Vd from a power supply line 301.

The potential of the capacitor 322 is adapted to be output from a signal output line 302 via amplification transistors 324 and 325.

The transfer gate 321, the reset gate 323, and the amplification transistors 324 and 325 can be configured by, for example, field effect transistors (MOSFETs).

Referring back to FIG. 10, the A/D conversion sections 143 compare output results of the photodiodes 141 with a reference voltage supplied from the reference-signal generating section 131 to convert analog signals, which are the output results of the photodiodes 141, into digital signals in, for example, a column ADC (Analog Digital Converter) system.

The digital memory sections 144 store the digital signals of the output results of the photodiodes 141 converted by the A/D conversion sections 143 corresponding to the digital memory sections 144. The output section 145 outputs the digital signals of the output results of the photodiodes 141 retained in the digital memory sections 144 to the output circuit 132.

The output circuit 132 outputs the signal from the output section 145 and the signal from the monitor sensor 122 to the CPU 31 (or the lens control section 22).

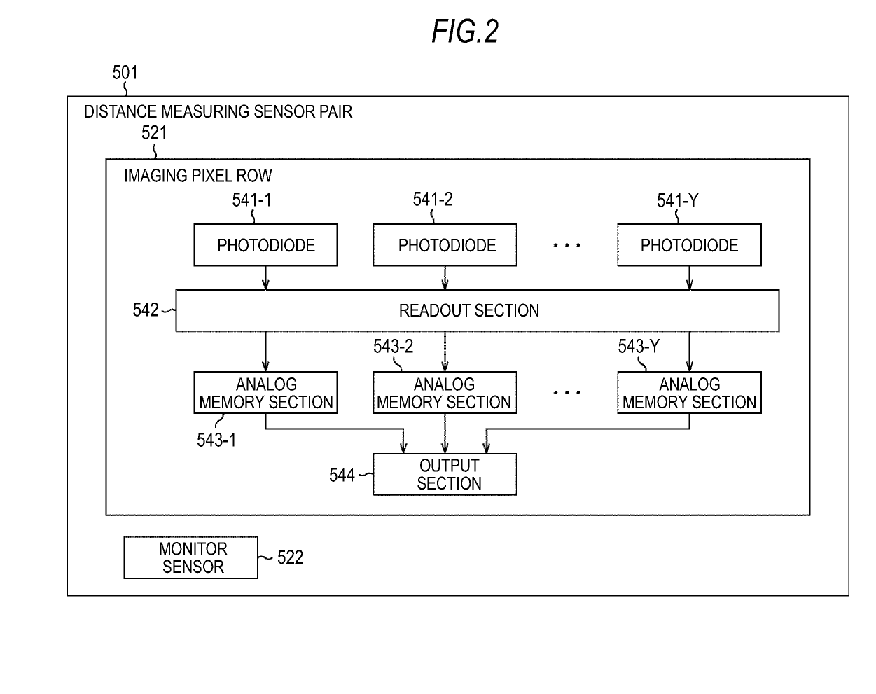

In such an imaging pixel row 121 shown in FIG. 10, the output results of the photodiodes 141 are stored in the digital memory sections 144 instead of the analog memory sections (see FIG. 2). Therefore, it is possible to prevent noise components from increasing because of heat or the like.

As explained above, when the output results of the photodiodes 141 are recorded in the digital memory sections 144, it is necessary to perform A/D conversion after the end of accumulations by the photodiodes 141.

The A/D conversion sections 143 of each of the distance measuring sensor pairs 41 execute the A/D conversion of the output results of the photodiodes 141 using a common output from one reference-signal generating section 131. The accumulations by the photodiodes 141 in one distance measuring sensor pair 41 end at the same timing.

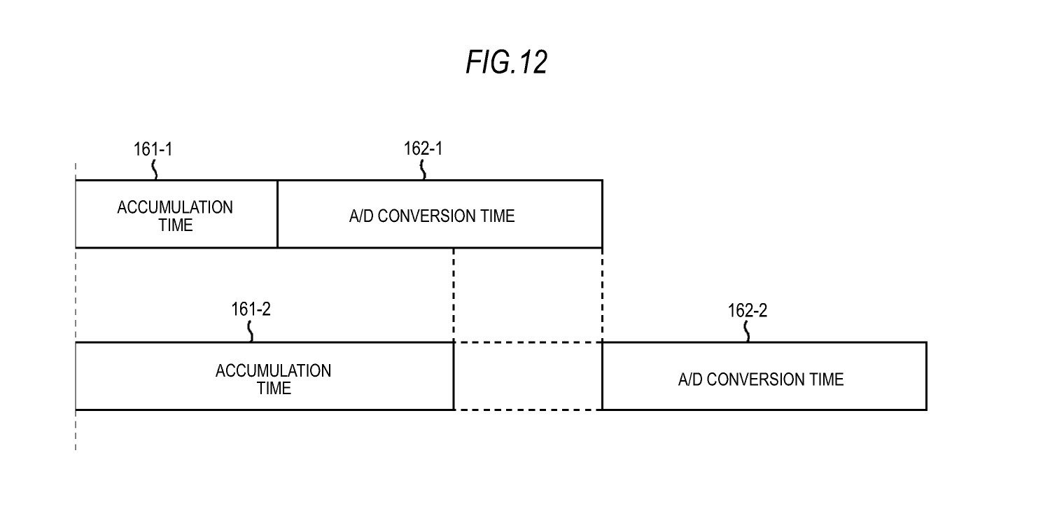

However, when the plural distance measuring sensor pairs 41-1 to 41-M are processed using the one reference-signal generating section 131, a data loss could occur in the output results of the photodiodes 141. The data loss that occurs in the output results of the photodiodes 141 is explained with reference to FIG. 12.

FIG. 12 is a diagram of an example of an accumulation time of the photodiodes 141. An accumulation time 161-1 indicates an accumulation time of the photodiodes 141 of the distance measuring sensor pair 41-1. An accumulation time 161-2 indicates an accumulation time of the photodiodes 141 of the distance measuring sensor pair 41-2.

In the explanation of the example shown in FIG. 12, the accumulation time 161-1 is set to 3 μs, the accumulation time 161-2 is set to 6 μs, and an A/D conversion time 162 is set to 5 μs. The accumulation times are respectively set to accumulation times in which optimum outputs can be obtained from the distance measuring sensor pairs 41.

As shown in FIG. 12, accumulations by the photodiodes 141 of the distance measuring sensor pair 41-1 are performed in the accumulation time 161-1. Thereafter, the A/D conversion is executed.

However, when the accumulations by the photodiodes 141 of the distance measuring sensor pair 41-1 end and the accumulation time 161-2 of the photodiodes 141 of the distance measuring sensor pair 41-2 elapses while the A/D conversion is executed, i.e., in the A/D conversion time 162-1, since the one reference-signal generating section 131 is currently operating for the distance measuring sensor pair 41-1, the A/D conversion is not immediately executed.

In such a case, the accumulations by the photodiodes 141 of the distance measuring sensor pair 41-2 do not end in the accumulation time 161-2 of 6 μs. The accumulation is performed until the A/D conversion time 162-1 of the distance measuring sensor pair 41-1 elapses, i.e., 8 μs elapses.

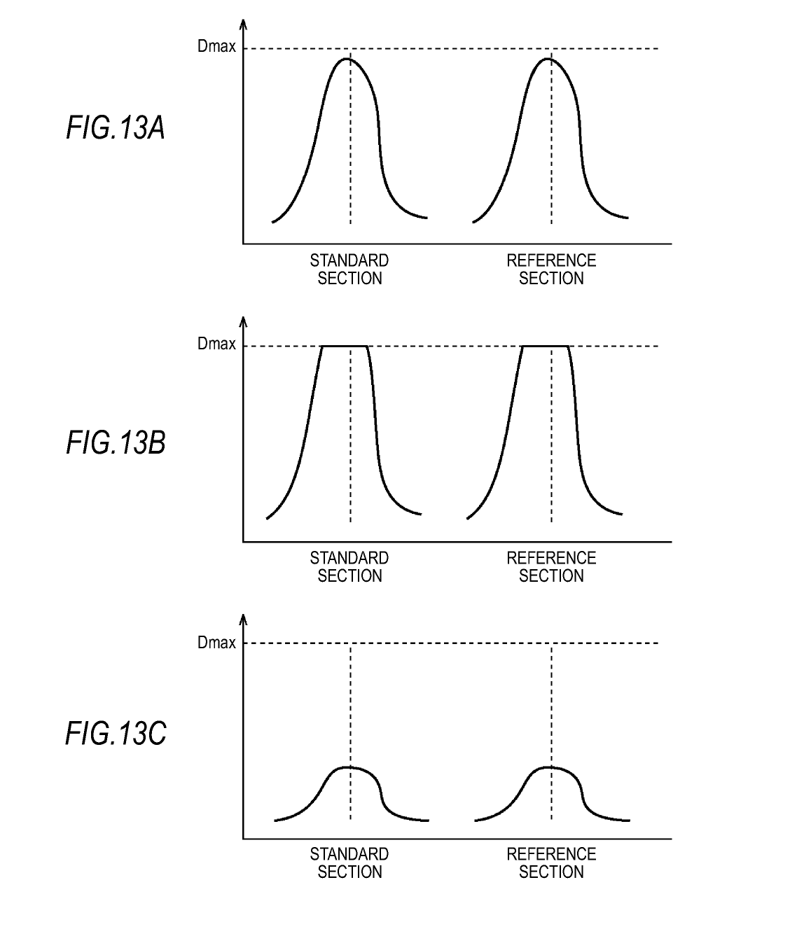

Therefore, since the accumulation time of the photodiodes 141 of the distance measuring sensor pair 41-2 is extended by 2 μs, it is likely that an accumulation amount of the photodiodes 141 of the distance measuring sensor pair 41-2 is saturated and a data loss occurs. Outputs of the photodiodes 141 are explained with reference to FIGS. 13A to 13C.

FIGS. 13A to 13C are diagrams of examples of the outputs of the photodiodes 141. In the examples shown in FIGS. 13A to 13C, the positions of the photodiodes 141-1 to 141-N are indicated by the abscissa. Accumulation amounts of the photodiodes 141, i.e., the outputs of the photodiodes 141 are indicated by the ordinate.

A standard section indicates, for example, the photodiodes 141 of the sensor row 101-1. A reference section indicates, for example, the photodiodes 141 of the sensor row 101-2.

Dmax indicates a maximum of a dynamic range of the photodiodes 141 set for each of the distance measuring sensor pairs 41.

In FIG. 13A, an example of optimum outputs of the photodiodes 141 is shown. When the outputs of the photodiodes 141 are the optimum outputs, the outputs of the photodiodes 141 are within a dynamic range.

In FIG. 13B, an example of excessively large outputs of the photodiodes 141 is shown. When the outputs of the photodiodes 141 are excessively large, the outputs exceed the dynamic range. Since the outputs of the photodiodes 141 equal to or larger than Dmax may not be able to be detected, a data loss occurs.

When an accumulation time is long like the accumulation time 161-2 of the photodiodes 141 of the distance measuring sensor pair 41-2 shown in FIG. 12 or when strong light is made incident, the outputs of the photodiodes 141 could exceed the dynamic range.

In FIG. 13C, an example of excessively small outputs of the photodiodes 141 is shown. When an accumulation time of the photodiodes 141 is excessively short or when weak light is made incident, the outputs of the photodiodes 141 are excessively small and an S/N is deteriorated.

When the outputs of the photodiodes 141 are not optimum as shown in FIGS. 13B and 13C, AF processing by the outputs of the distance measuring sensor pairs 41 may not be able to be surely executed.

In order to prevent the phenomenon shown in FIG. 13B, it is conceivable to arrange the reference-signal generating section 131 for each of the distance measuring sensor pairs 41.

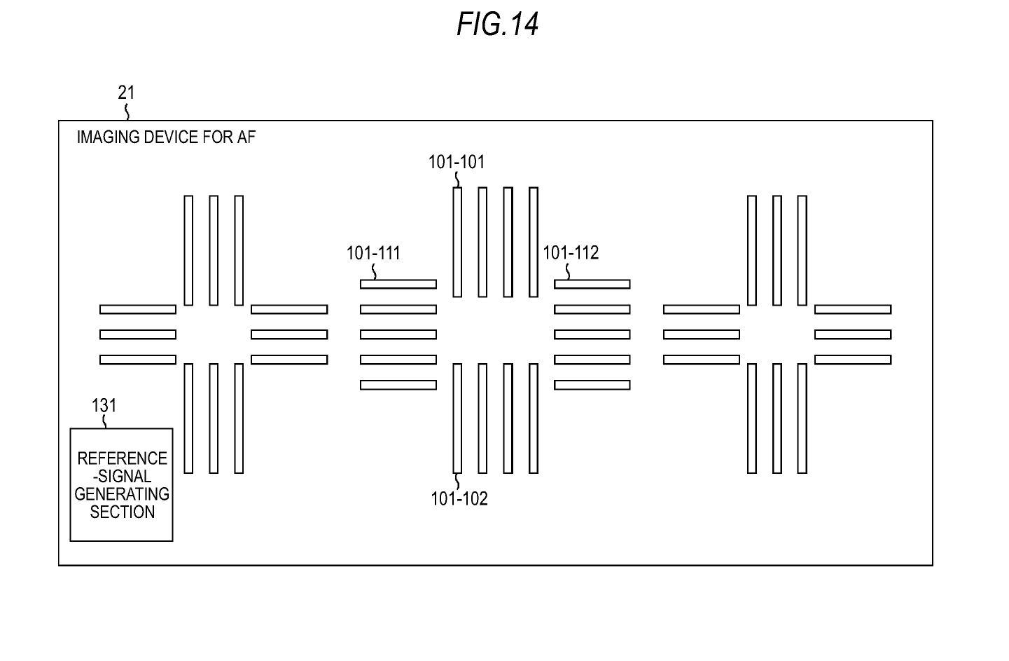

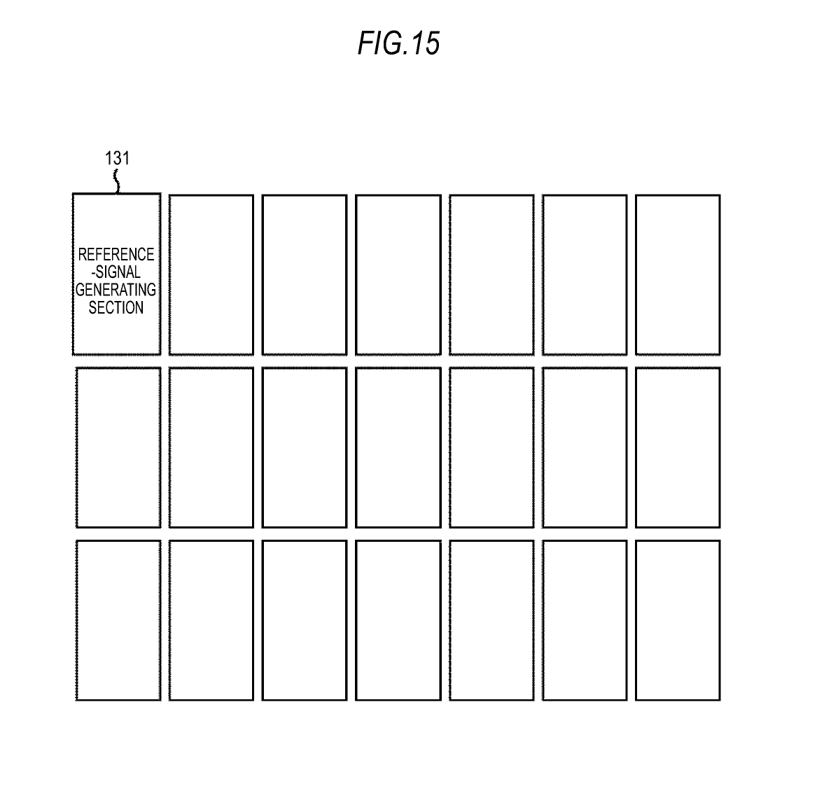

Plural reference-signal generating sections 131 set in the imaging device for AF 21 are explained with reference to FIGS. 14 and 15.

FIG. 14 is a diagram of an arrangement example on the inside of a chip of the imaging device for AF 21. In FIG. 14, an arrangement example in which the number of the distance measuring sensor pairs 41 of the imaging device for AF 21 shown in FIG. 9 is twenty one (M=21) is shown.

In the example shown in FIG. 14, in the chip of the imaging device for AF 21, the twenty-one distance measuring sensor pairs 41 including a pair of sensor rows 101-101 and 101-102 and a pair of sensor rows 101-111 and 101-112 are arranged and the one reference-signal generating section 131 is arranged.

FIG. 15 is a diagram of an example of the twenty-one reference-signal generating section 131. The scale of FIG. 15 is the same as the scale of FIG. 14.

As shown in FIG. 14, the size of the reference-signal generating section 131 is sufficiently larger than one distance measuring sensor pair 41. Therefore, it may be difficult to arrange all the twenty-one reference-signal generating sections 131 shown in FIG. 15 in the chip of the imaging device for AF 21 shown in FIG. 14. When the number of the reference-signal generating sections 131 increases, costs increase.

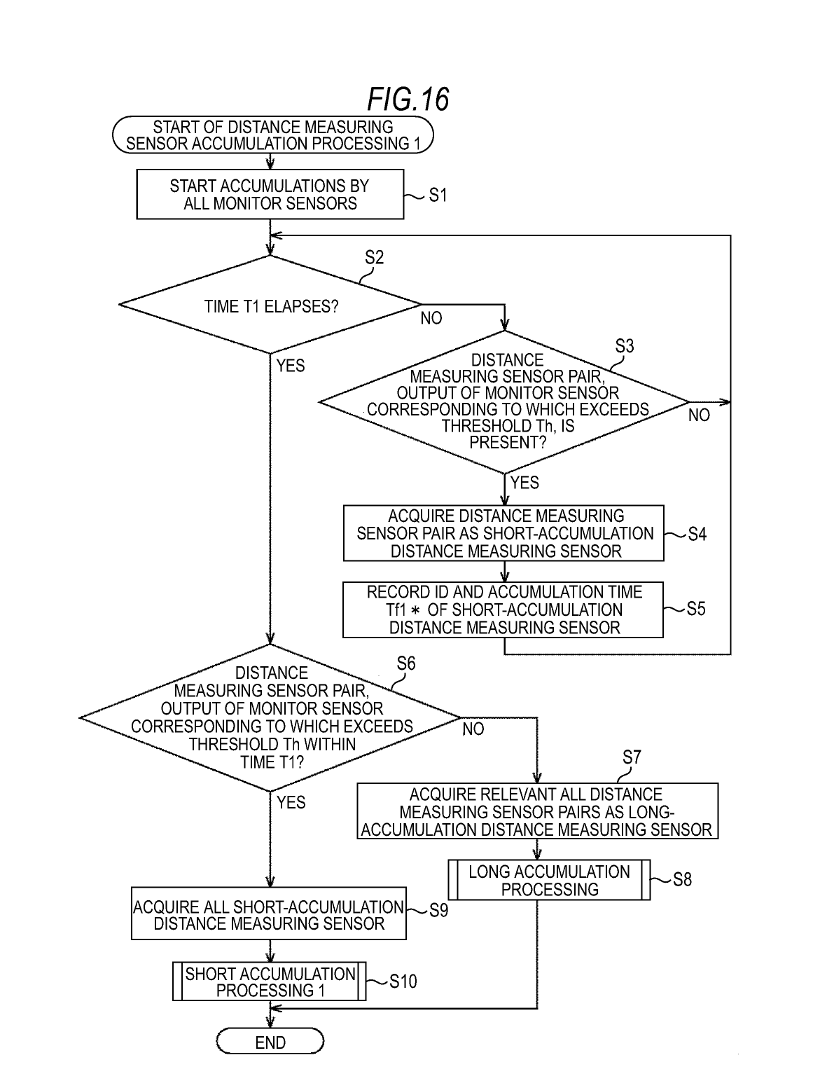

In order to prevent such a problem from occurring, it is desirable to subject the outputs of the distance measuring sensor pairs 41-1 to 41-M to the A/D conversion using the one reference-signal generating section 131. Distance measuring sensor accumulation processing by the single lens reflex camera 1 for that purpose is explained with reference to FIGS. 16 to 20.

### [Distance Measuring Sensor Accumulation Processing 1]

FIG. 16 is a flowchart for explaining the distance measuring sensor accumulation processing 1. The distance measuring sensor accumulation processing 1 is executed, for example, during an AF operation. For simplification of explanation, processing by one of two sensor rows 101 of the distance measurement sensor pair 41 is described as processing by the distance measuring sensor pair 41.

In step S1, the control section 51 starts accumulations by all the monitor sensors 122. In other words, accumulations by the monitor sensors 122 of all the distance measuring sensor pairs 41-1 to 41-M are started.

In step S2, the determining section 52 determines whether time T1 elapses. The time T1 is set in advance as a threshold for switching a short accumulation mode and a long accumulation mode of the distance measuring sensor pair 41.

In the following explanation, the distance measuring sensor pair 41 in the short accumulation mode is described as short-accumulation distance measuring sensor and the distance measuring sensor pair 41 in the long accumulation mode is described as long-accumulation distance measuring sensor.

In the explanation of this embodiment, the time T1 is the same time for all the distance measuring sensor pairs 41. However, the time T1 may be different time for each of the distance measuring sensor pairs 41.

When the determining section 52 determines in step S2 that the time T1 does not elapse yet, in step S3, the determining section 52 determines whether the distance measuring sensor pair 41, an output of the monitor sensor 122 corresponding to which exceeds a threshold Th, is present.

In other words, the determining section 52 determines whether the distance measuring sensor pair 41 in which an accumulation by the monitor sensor 122 ends is present at the present point within the time T1.

In this embodiment, time until the output of the corresponding monitor sensor 122 exceeds the threshold Th is set as an optimum time for the accumulations by the photodiodes 141 of the distance measuring sensor pair 41. However, other values may be set as a threshold.

For example, a half value of the threshold Th may be set as the threshold. When the half value of the threshold Th is set as the threshold, double time of time in which the output of the monitor sensor 122 exceeds the threshold is the optimum time for the accumulations by the photodiodes 141.

Monitor sensitivity or the like of the monitor sensor 122 may be adjusted while the threshold Th is kept. When the monitor sensitivity is doubled, double time of time in which the output of the monitor sensor 122 exceeds the threshold Th is the optimum time for the accumulations by the photodiodes 141.

When the determining section 52 determines in step S3 that the distance measuring sensor pair 41 in which the accumulation by the monitor sensor 122 ends is absent at the present point within the time T1, the processing returns to step S2 and the same processing is repeated in step S2 and subsequent steps.

On the other hand, when the determining section 52 determines in step S3 that the distance measuring sensor pair 41 in which the accumulation by the monitor sensor 122 ends is present at the present point within the time T1, in step S4, the acquiring section 53 acquires the distance measuring sensor pair 41 as a short-accumulation distance measuring sensor.

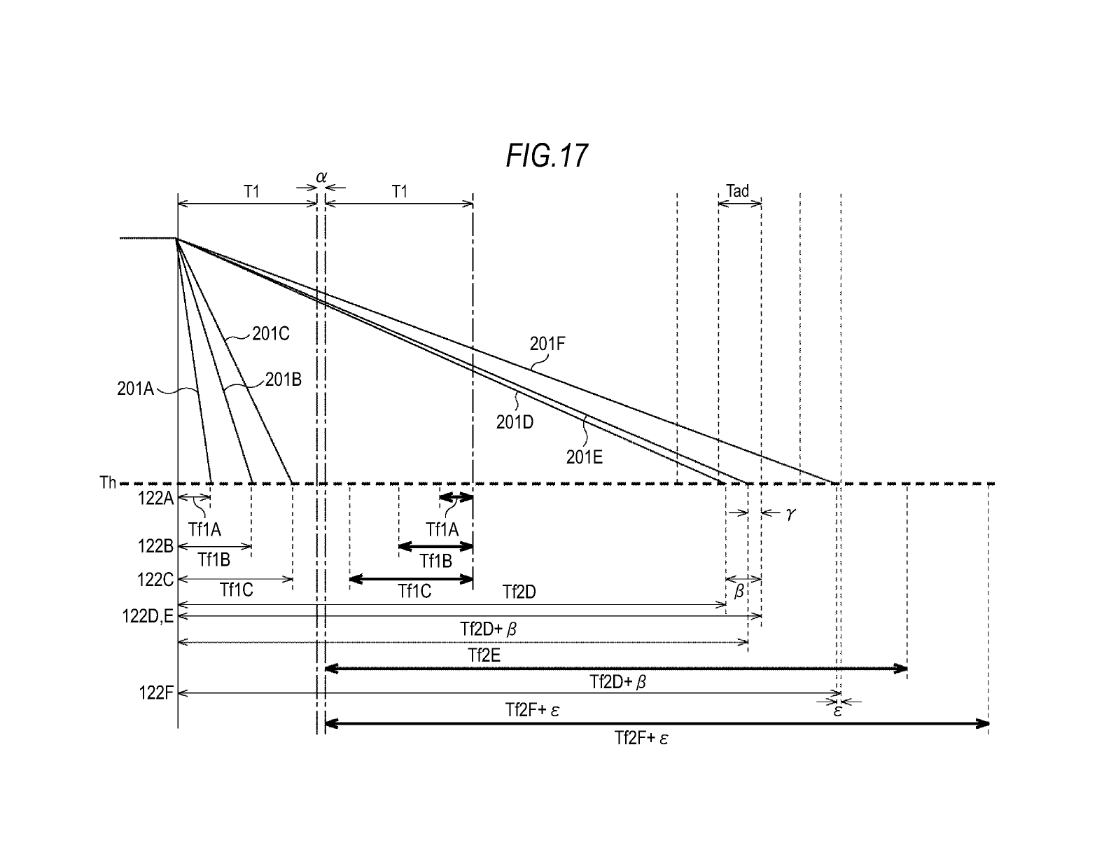

An output of the monitor sensor 122 exceeding the threshold Th within the time T1 is explained with reference to FIG. 17.

FIG. 17 is a timing chart of an example of an accumulation by the distance measuring sensor pair 41. In the example shown in FIG. 17, accumulation states of monitor sensors 122A, 122B, 122C, 122D, 122E, and 122F are shown.

The ordinate of FIG. 17 indicates outputs of the monitor sensors 122. The downward direction of the figure indicates a plus direction. The abscissa indicates an elapsed time.

When accumulations by the monitor sensors 122 are started, outputs 201 of the monitor sensors 122 increase to the threshold Th (in the downward direction in FIG. 17).

In the example shown in FIG. 17, an output 201A of the monitor sensor 122A, an output 201B of the monitor sensor 122B, and an output 201C of the monitor sensor 122C exceed the threshold Th in this order.

An elapsed time until the output 201A exceeds the threshold Th is represented as accumulation time Tf1A, an elapsed time until the output 201B exceeds the threshold Th is represented as accumulation time Tf1B, and an elapsed time until the output 201C exceeds the threshold Th is represented as accumulation time Tf1C.

On the other hand, an output 201D of the monitor sensor 122D, an output 201E of the monitor sensor 122E, and an output 201F of the monitor sensor 122F do not exceeds the threshold Th within the time T1.

Referring back to FIG. 16, in step S5, the recording section 54 records an ID (Identification) and an accumulation time Tf1* of the short-accumulation distance measuring sensor. The ID is, for example, a name of the short-accumulation distance measuring sensor.

The accumulation time Tf1* is time that elapses from the start of accumulations by the monitor sensors 122 until the outputs of the monitor sensors 122 exceed the threshold Th. “*” of the accumulation time Tf1* indicates IDs or the like of the short-accumulation distance measuring sensors corresponding to the monitor sensors 122.

For example, in the case of a short-accumulation distance measuring sensor A, an ID “A” of the short-accumulation distance measuring sensor A and an accumulation time Tf1A of the short-accumulation distance measuring sensor A are recorded.

After the processing in step S5, the processing returns to step S2 and the processing in step S2 and subsequent steps is repeated.

According to the repetition of the processing in steps S2 to S5, a distance measuring sensor pair 41B corresponding to the monitor sensor 122B is acquired as a short-accumulation distance measuring sensor B. An ID “B” and an accumulation time Tf1B of the short-accumulation distance measuring sensor B are recorded.

Similarly, a distance measuring sensor pair 41C corresponding to the monitor sensor 122C is acquired as a short-accumulation distance measuring sensor C. An ID “C” and an accumulation time Tf1C of the short-accumulation distance measuring sensor C are recorded.

On the other hand, when the determining section 52 determines in step S2 that the time T1 elapses, in step S6, the determining section 52 determines whether the distance measuring sensor pair 41 is the distance measuring sensor pair 41, an output of the monitor sensor 122 corresponding to which exceeds the threshold Th within the time T1.

In other words, the determining section 52 determines whether the distance measuring sensor pair 41 is a short-accumulation distance measuring sensor or a long-accumulation distance measuring sensor.

When the determining section 52 determines in step S6 that the distance measuring sensor pair 41 is not the distance measuring sensor pair 41, the output of the monitor sensor 122 corresponding to which exceeds the threshold Th within the time T1, i.e., when the determining section 52 determines that the distance measuring sensor pair 41 is a long-accumulation distance measuring sensor, the processing proceeds to step S7.

In step S7, the acquiring section 53 acquires the relevant all distance measuring sensor pairs 41 as long-accumulation sensors. In the example shown in FIG. 17, distance measuring sensor pairs 41D, 41E, and 41F corresponding to the monitor sensors 122D, 122E, and 122F are acquired as long-accumulation distance measuring sensors D, E, and F.

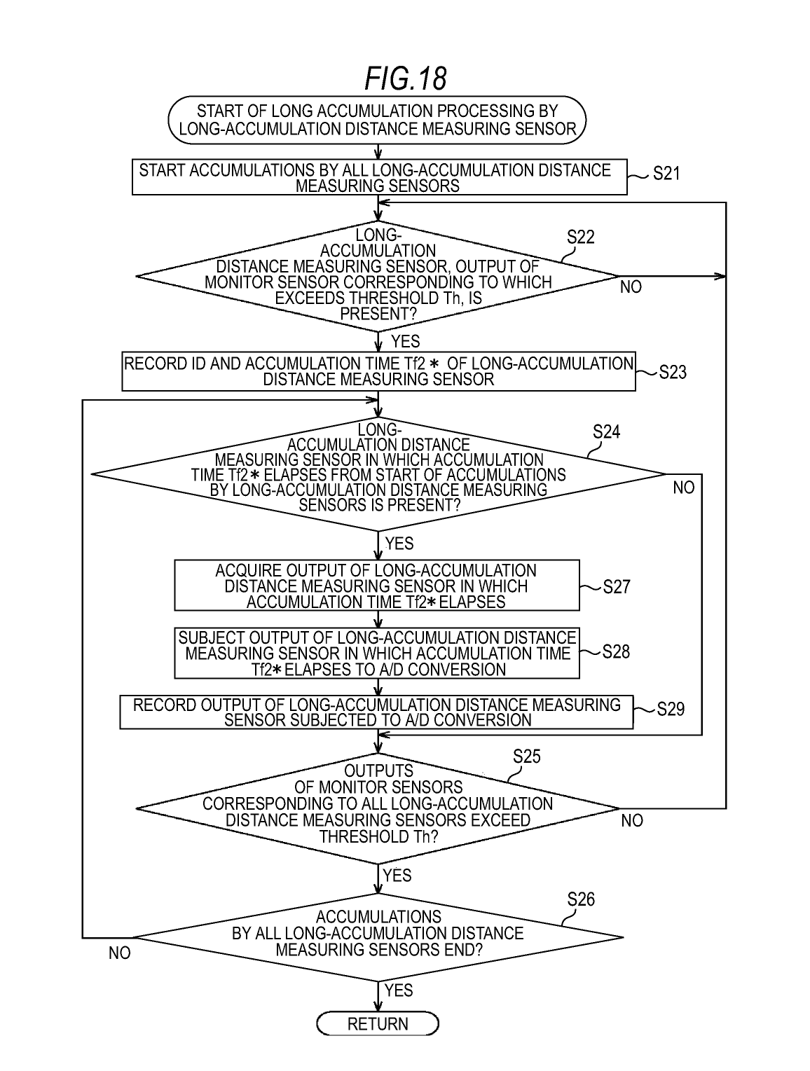

In step S8, the CPU 31 executes long accumulation processing. The long accumulation processing by the long-accumulation distance measuring sensor is explained with reference to FIG. 18.

### [Long Accumulation Processing]

FIG. 18 is a flowchart for explaining the long accumulation processing by the long-accumulation distance measuring sensor.

In step S21, the control section 51 starts accumulations by all the long-accumulation distance measuring sensors. More accurately, the control section 51 starts accumulations by the imaging pixel rows 121 of all the long-accumulation distance measuring sensors.

Specifically, after the elapse of time (T1+α (α is a real number)) from the start of the accumulations by the monitor sensors 122 according to the processing in step S1 in FIG. 16, the control section 51 starts accumulations by the photodiodes 141 of the long-accumulation distance measuring sensors D, E, and F.

The time α is very short time corresponding to the processing time in steps S6 and S7 in FIG. 16.

In step S22, the determining section 52 determines whether a long-accumulation distance measuring sensor, an output of the monitor sensor 122 corresponding to which exceeds the threshold Th, is present. In other words, the determining section 52 determines whether a long-accumulation distance measuring sensor in which an accumulation time of the distance measuring sensor pair 41 is determined is present.

When the determining section 52 determines in step S22 that a long-accumulation distance measuring sensor in which an accumulation time is determined is absent, the processing returns to step S22 and the processing in step S22 and subsequent steps is repeated.

On the other hand, when the determining section 52 determines in step S22 that a long-accumulation distance measuring sensor in which an accumulation time is determined is present, in step S23, the recording section 54 records an ID and an accumulation time Tf2* of the long-accumulation distance measuring sensor.

In the example shown in FIG. 17, the output 201D of the monitor sensor 122D exceeds the threshold Th when an accumulation time Tf2D elapses from the start of the accumulations by the monitor sensors 122.

At this point, an ID “D” of a long-accumulation distance measuring sensor D corresponding to the monitor sensor 122D and the accumulation time Tf2D of the long-accumulation distance measuring sensor D are recorded.

In the case of the long-accumulation distance measuring sensor, the accumulation time Tf2* is controlled at the interval of time Tad of the A/D conversion. In FIG. 17, dotted lines indicate timing of processing of the A/D conversion.

In the example shown in FIG. 17, when the accumulation time Tf2D elapses from the start of the accumulations by the monitor sensors 122, the output 201D of the monitor sensor 122D exceeds the threshold Th. When an accumulation time Tf2E elapses, the output 201E of the monitor sensor 122E exceeds the threshold Th.

In such a case, the accumulation times Tf2D and Tf2E are different times. However, since the accumulation times Tf2D and Tf2E are within a range of the same time Tad, timing when the output 201E of the monitor sensor 122E exceeds the threshold Th is the same as timing when the output 201D exceeds the threshold Th. This is because the time Tad is sufficiently small compared with the accumulation time of the long-accumulation distance measuring sensor.

Specifically, when time Tf2D+β (=Tf2E+γ((β, γ<Tad, β and γ are real numbers)) elapses from the start of the accumulations by the monitor sensors 122, the outputs 201D and 201E are assumed to exceed the threshold Th. β and γ indicate time until the next timing of the A/D conversion.

In step S24, the determining section 52 determines whether a long-accumulation distance measuring sensor in which the accumulation time Tf2* elapses from the start of accumulations by the long-accumulation distance measuring sensors is present. In other words, the determining section determines whether the accumulations by the long-accumulation distance measuring sensors end.

When the determining section 52 determines in step S24 that the accumulations by the long-accumulation distance measuring sensors do not end yet, processing in steps S27 to S29 explained below is skipped. The processing proceeds to step S25.

In step S25, the determining section 52 determines whether outputs of the monitor sensors 122 corresponding to all the long-accumulation distance measuring sensors exceed the threshold Th. In other words, the determining section 52 determines whether accumulation times of all the long-accumulation distance measuring sensors are determined.

When the determining section 52 determines in step S25 that accumulation times of all the long-accumulation distance measuring sensors are not determined yet, the processing returns to step S22 and the processing in step S22 and subsequent steps is repeated.

On the other hand, when the determining section 52 determines in step S25 that accumulation times of all the long-accumulation distance measuring sensors are determined, in step S26, the determining section 52 determines whether the accumulations by all the long-accumulation distance measuring sensors end.

In the example shown in FIG. 17, according to the repetition of the processing in steps S22 to S25, after accumulation times of the long-accumulation distance measuring sensors D and E are determined, the output 201F of the monitor sensor 122F exceeds the threshold Th and an ID “F” and an accumulation time Tf2F of the long-accumulation distance measuring sensor F are recorded.

Therefore, the accumulation time Tf2F of the long-accumulation distance measuring sensor F is determined and accumulation times of all the long-accumulation distance measuring sensors D, E, and F are determined.

When the determining section 52 determines in step S26 that the accumulations by all the long-accumulation distance measuring sensors do not end yet, i.e., when a long-accumulation distance measuring sensor that does not end accumulation is present, the processing returns to step S24 and the processing in step S24 and subsequent steps is repeated.

On the other hand, when the determining section 52 determines in step S24 that the accumulations by the long-accumulation distance measuring sensors end, in step S27, the acquiring section 53 acquires an output of the long-accumulation distance measuring sensor in which the accumulation time Tf2* elapses.

In step S28, the control section 51 subjects an output of the long-accumulation distance measuring sensor in which the accumulation time Tf2* elapses to the A/D conversion.

Specifically, the control section 51 controls the A/D conversion sections 143 and subjects outputs of the photodiodes 141 to the A/D conversion using a reference voltage output by the reference-signal generating section 131.

In the example shown in FIG. 17, when an accumulation time Tf2D+β (=Tf2E+γ) elapses from the start of the accumulations by the long-accumulation distance measuring sensors, outputs of the long-accumulation distance measuring sensors D and E are acquired.

In this case, the control section 51 controls an A/D conversion section 143D of the long-accumulation distance measuring sensor D, i.e., the distance measuring sensor pair 41D to subject an output of a photodiode 141D to the A/D conversion.

Similarly, the control section 51 controls an A/D conversion section 143E of the long-accumulation distance measuring sensor E, i.e., the distance measuring sensor pair 41E to subject an output of a photodiode 141E to the A/D conversion.

The control section 51 controls the A/D conversion sections 143 in the above explanation. However, the A/D conversion sections 143 may independently subject outputs of the photodiodes 141 to the A/D conversion without depending on the control by the control section 51.

In step S29, the recording section 54 records the output of the long-accumulation distance measuring sensor subjected to the A/D conversion.

Specifically, for each of the sensor rows 101, the output of the photodiode 141D is recorded in a digital memory section 144D and the output of the photodiode 141E is recorded in a digital memory section 141E.

After the processing in step S29, the processing proceeds to step S25 and the processing in step S25 and subsequent steps is repeated.

According to the repetition of the processing in steps S24 to S29, when an accumulation time Tf2F+ε (ε<Tad, ε is a real number) elapses from the start of the accumulations by the long-accumulation distance measuring sensors, an output of the long-accumulation distance measuring sensor F is acquired. ε is also time until the next timing of the A/D conversion.

An output of a photodiode 141F of the long-accumulation distance measuring sensor F is subjected to the A/D conversion and recorded in a digital memory section 144F.

When the determining section 52 determines in step S26 that the accumulations by all the long-accumulation distance measuring sensors end, the long accumulation processing by the long-accumulation distance measuring sensor ends and the processing returns to FIG. 16.

Referring back to FIG. 16, when the determining section 52 determines in step S6 that the distance measuring sensor pair 41 is a short-accumulation distance measuring sensor, in step S9, the acquiring section 53 acquires all short-accumulation distance measuring sensors. In the example shown in FIG. 17, short-accumulation distance measuring sensors A, B, and C are acquired.

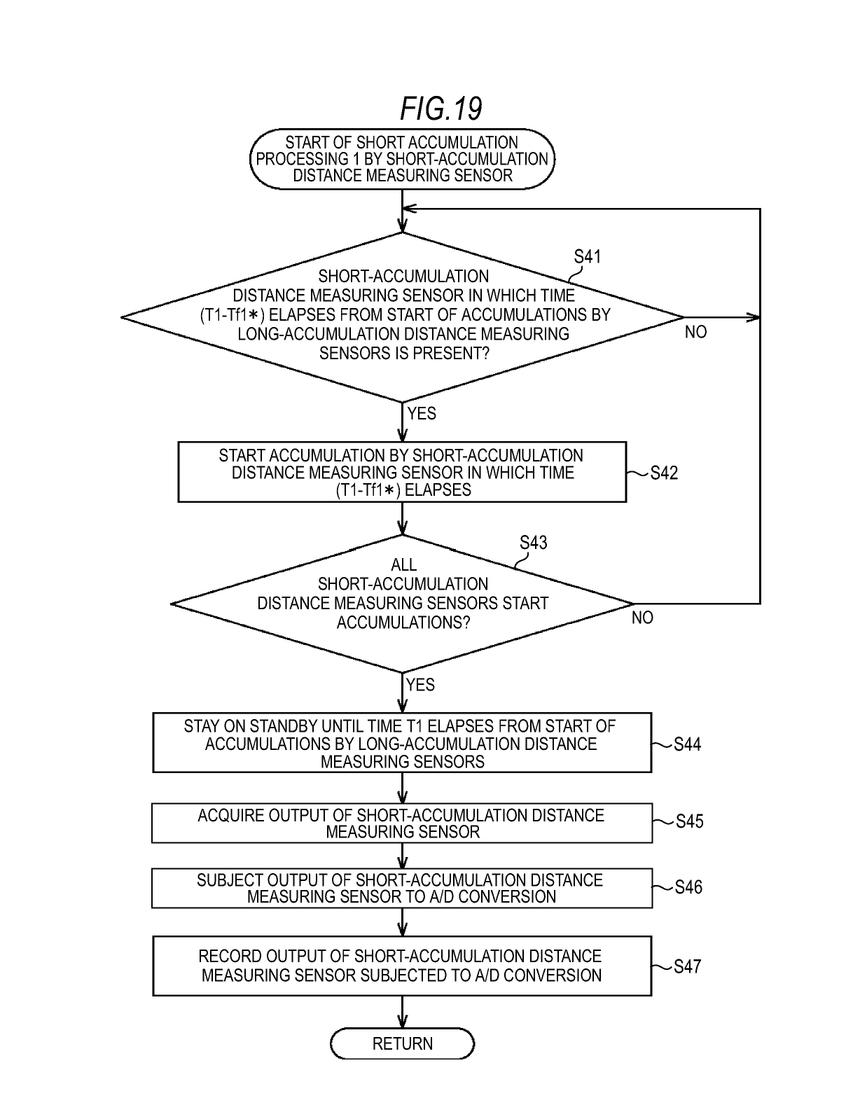

In step S10, the CPU 31 executes short accumulation processing 1. The short accumulation processing 1 by the short-accumulation distance measuring sensor is explained with reference to FIG. 19.

### [Short Accumulation Processing 1]

FIG. 19 is a flowchart for explaining the short accumulation processing 1 by the short-accumulation distance measuring sensor.

In step S41, the determining section 52 determines whether a short-accumulation distance measuring sensor in which time (T1−Tf1*) elapses from the start of the accumulations by the long-accumulation distance measuring sensors is present. In other words, the determining section 52 determines whether a short-accumulation distance measuring sensor that starts accumulations by the photodiodes 141 is present.

The accumulations by the long-accumulation distance measuring sensors are started when the processing in step S21 in FIG. 18 is executed, i.e., when time (T1+α) elapses after the start of the accumulations by the monitor sensors 122.

When the determining section 52 determines in step S41 that a short-accumulation distance measuring sensor that starts accumulation is not present yet, the processing returns to step S41 and the same processing is repeated.

When the determining section 52 determines in step S41 that a short-accumulation distance measuring sensor that starts accumulation is present, in step S42, the control section 51 starts the accumulation by the short-accumulation distance measuring sensor in which the accumulation time (T1−Tf1*) elapses.

In the case of the short-accumulation distance measuring sensors A, B, and C, according to the processing in steps S2 to S5 in FIG. 16, the short-accumulation distance measuring sensor C in which an output of the monitor sensor 122 exceeds the threshold Th last starts accumulation first.

In other words, when time (T1−Tf1C) elapses from the start of the accumulations by the long-accumulation distance measuring sensors, the accumulation by the short-accumulation distance measuring sensor C is started.

In step S43, the determining section 52 determines whether all the short-accumulation distance measuring sensors start accumulations.

When the determining section 52 determines in step S43 that not all the short-accumulation distance measuring sensors start accumulations, i.e., when the determining section 52 determines that a short-accumulation distance measuring sensor that does not start accumulation yet is present, the processing returns to step S41 and the processing in step S41 and subsequent steps is repeated.

According to the repetition of the processing in steps S41 to S43, when time (T1−Tf1B) elapses from the start of the accumulations by the long-accumulation distance measuring sensors, an accumulation by the short-accumulation distance measuring sensor B is started. When time (T1−Tf1A) elapses from the start of the accumulations by the long-accumulation distance measuring sensors, an accumulation by the short-accumulation distance measuring sensor A is started.

By adjusting timing of the start of the accumulations in this way, the accumulations by the short-accumulation distance measuring sensors A, B, and C end at the same timing.

When the determining section 52 determines in step S43 that all the short-accumulation distance measuring sensors start accumulations, in step S44, the control section 51 stays on standby until the time T1 elapses from the start of the accumulations by the long-accumulation distance measuring sensors. In other words, the control section 51 stays on standby until the accumulations by all the short-accumulation distance measuring sensors A, B, and C end.

In step S45, the acquiring section 53 acquires an output of the short-accumulation distance measuring sensor. Specifically, the acquiring section 53 acquires outputs of the photodiodes 141-1 to 141-N via the readout section 142.

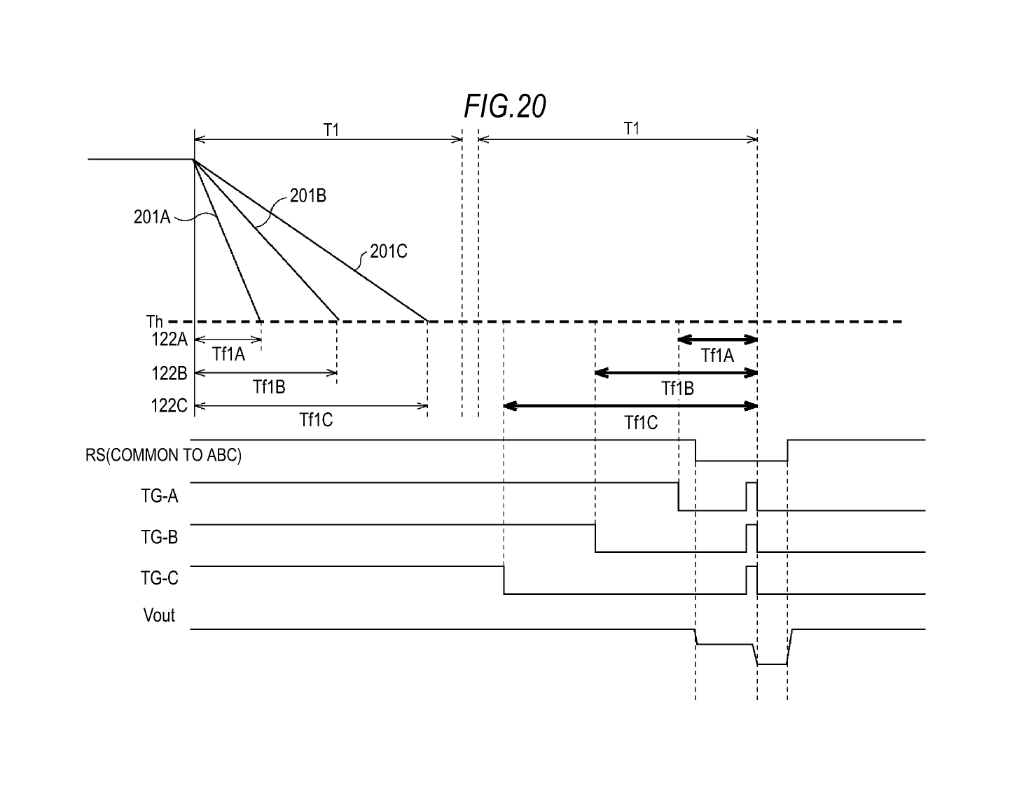

Readout of output results of the photodiodes 141 is explained with reference to FIG. 20. FIG. 20 is a timing chart of accumulations and readouts by the short-accumulation distance measuring sensors.

In an example shown in FIG. 20, for simplification of explanation, an example of accumulation and readout by the photodiode 141-1 of one sensor row 101 of the short-accumulation distance measuring sensors A, B, and C is shown. Vout indicates an output result of the one sensor row 101 of the short-accumulation distance measuring sensor A.

In the example shown in FIG. 20, time (T1−Tf1C) from the start of the accumulations by the long-accumulation distance measuring sensors is counted down. A signal TG-C changes from a high level to a low level at timing when the count reaches 0.

In other words, an accumulation by the short-accumulation distance measuring sensor C is started when the time (T1−Tf1C) elapses from the start of the accumulations by the long-accumulation distance measuring sensors.

Similarly, time (T1−Tf1B) is counted down from the start of the accumulations by the long-accumulation distance measuring sensors. A signal TG-B changes from the high level to the low level at timing when the count reaches 0.

Further, time (T1−Tf1A) is counted down from the start of the accumulations by the long-accumulation distance measuring sensors. A signal TG-A changes from the high level to the low level at timing when the count reaches 0.

At timing slightly before the accumulations end, when a signal RS changes from the high level to the low level, the capacitor 322 is reset. The output Vout of the amplification transistors 324 and 325 may not be able to keep a power supply voltage Vd and falls to a first value according to the characteristics of capacitive coupling.

Further, when the signal TG-A changes to the high level at timing immediately before the end of the accumulations, charges of the photodiode 141-1 are transferred to the capacitor 322. Thereafter, when the signal TG-A changes to the low level at timing of the end of the accumulations, the output Vout of the amplification transistors 324 and 325 falls to a second value.

A difference between the first value and the second value is a final output of the photodiode 141. The same readout processing is applied to the other photodiodes 141 and an output of the short-accumulation distance measuring sensor A is obtained.

The same readout processing is applied to the short-accumulation distance measuring sensors B and C.

Referring back to FIG. 19, in step S46, the control section 51 subjects the output of the short-accumulation distance measuring sensor to the A/D conversion. Specifically, the control section 51 controls the A/D conversion sections 143 and subjects outputs of the photodiodes 141 to the A/D conversion using the reference voltage output by the reference-signal generating section 131.

Since the A/D conversions by the short-accumulation distance measuring sensors A, B, and C are performed at the same timing, reference voltages necessary for the respective A/D conversions can be a common reference voltage. Therefore, the number of the one reference-signal generating sections 131 can be reduced to one.

In step S47, the recording section 54 records the output of the short-accumulation distance measuring sensor subjected to the A/D conversion. In other words, an output of a photodiode 141A is recorded in a digital memory section 144A.

Similarly, outputs of photodiodes 141B and 141C are respectively recorded in digital memory sections 144B and 144C. After the processing in step S47, the short accumulation processing 1 ends and the processing returns to FIG. 16.

As explained above, in the short accumulation processing 1, the timings of the ends of the accumulations by all the short-accumulation distance measuring sensors are the same. Therefore, it is possible to surely subject the outputs of the photodiodes 141 to the A/D conversion using the one reference-signal generating section 131 without causing a data loss and the like.

The outputs of the photodiodes 141 are stored in the digital memory sections 144 corresponding thereto. Therefore, noise and the like do not increase until the long accumulation processing by the long-accumulation distance measuring sensor ends. It is possible to surely retain the outputs of the photodiodes 141.

Referring back to FIG. 16, after the long accumulation processing in step S8 and the short accumulation processing 1 in step S10, the distance measuring sensor accumulation processing 1 ends.

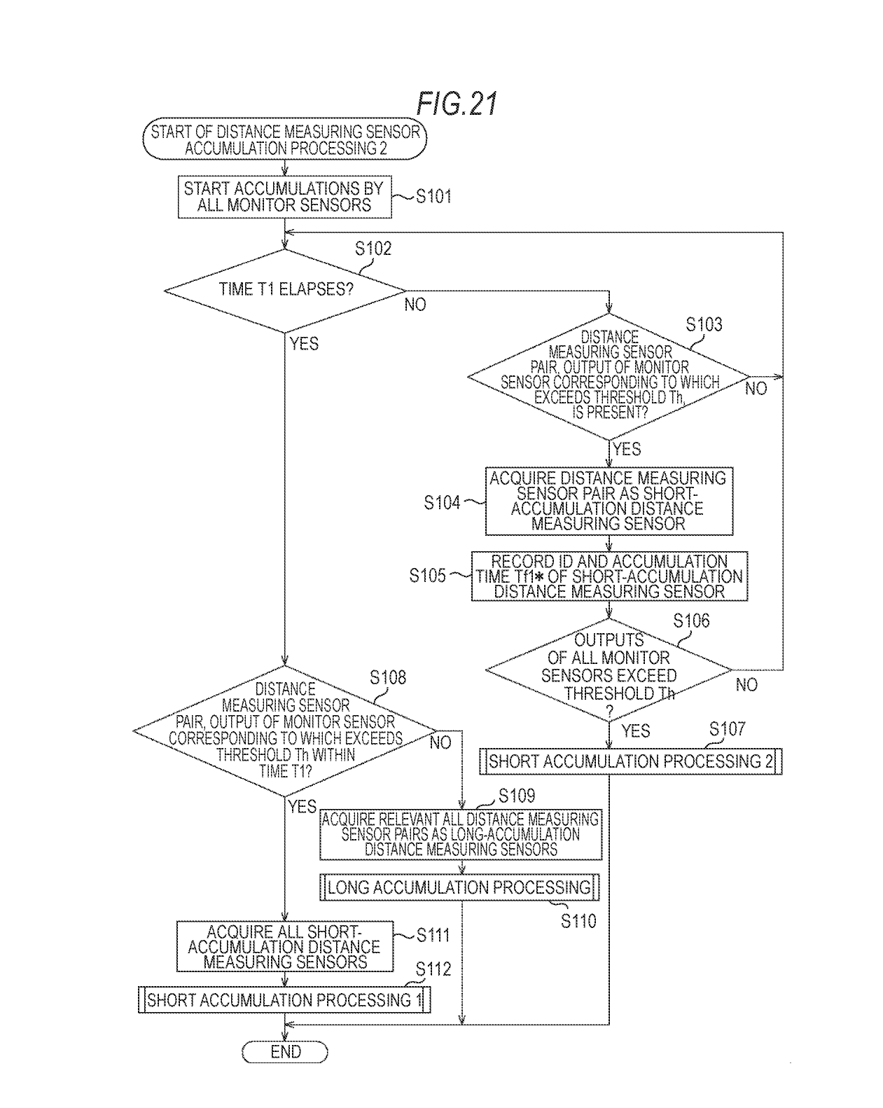

In this embodiment, the distance measuring sensor pair 41 is a short-accumulation distance measuring sensor or a long-accumulation distance measuring sensor. However, in some case, all the distance-measuring sensor pairs 41 are short-accumulation distance measuring sensors. Distance measuring sensor accumulation processing 2 in this case is explained with reference to FIGS. 21 to 23.

### [Distance Measuring Sensor Accumulation Processing 2]

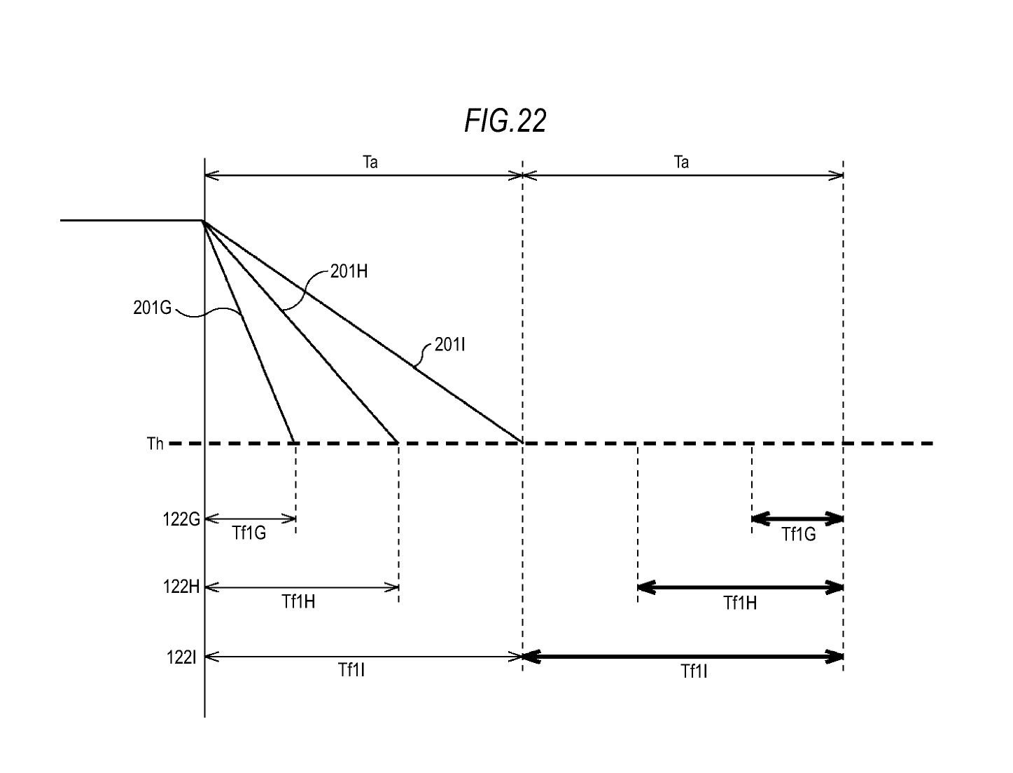

FIG. 21 is a flowchart for explaining the distance measuring sensor accumulation processing 2. FIG. 22 is a timing chart of an example of an accumulation by the distance measuring sensor pair 41. In the example shown in FIG. 22, outputs 201G, 201H, and 201I of monitor sensors 122G, 122H, and 122I are shown.

In FIG. 21, processing in steps S101 to S105 and S108 to S112 is processing corresponding to the processing in steps S1 to S10 in FIG. 16. Therefore, the processing in these steps is briefly explained because the explanation of the processing is repetitive.

In step S101, the control section 51 starts the accumulations by all the monitor sensors 122. In step S102, the determining section 52 determines whether the time T1 elapses.

When the determining section 52 determines in step S102 that the time T1 does not elapse yet, in step S103, the determining section 52 determines whether the distance measuring sensor pair 41, an output of the monitor sensor 122 corresponding to which exceeds the threshold Th, is present.

In other words, the determining section 52 determines whether the distance measuring sensor pair 41 that ends the accumulation within the time T1 is present. When the determining section 52 determines in step S103 that the distance measuring sensor pair 41 that ends the accumulation within the time T1 is absent, the processing returns to step S102 and the processing in step S102 and subsequent steps is repeated.

When the determining section 52 determines in step S103 that the distance measuring sensor pair 41 that ends the accumulation within the time T1 is present, in step S104, the acquiring section 53 acquires the distance measuring sensor pair 41 as a short-accumulation distance measuring sensor.

In step S105, the recording section 54 records an ID and the accumulation time Tf1* of the short-accumulation distance measuring sensor. For example, in FIG. 22, an ID “G” and an accumulation time Tf1G of a short-accumulation distance measuring sensor G is acquired.

In step S106, the determining section 52 determines whether outputs of all the monitor sensors 122 exceed the threshold Th. In other words, the determining section 52 determines whether all the distance measuring sensor pairs 41 are short-accumulation distance measuring sensors.

When the determining section 52 determines in step S106 that not all the distance measuring sensor pairs 41 are short-accumulation distance measuring sensors, i.e., when the distance measuring sensor pair 41, an output of the monitor sensor 122 corresponding to which does not exceed the threshold Th yet, is present, the processing returns to step S102 and the processing in step S102 and subsequent steps is repeated.

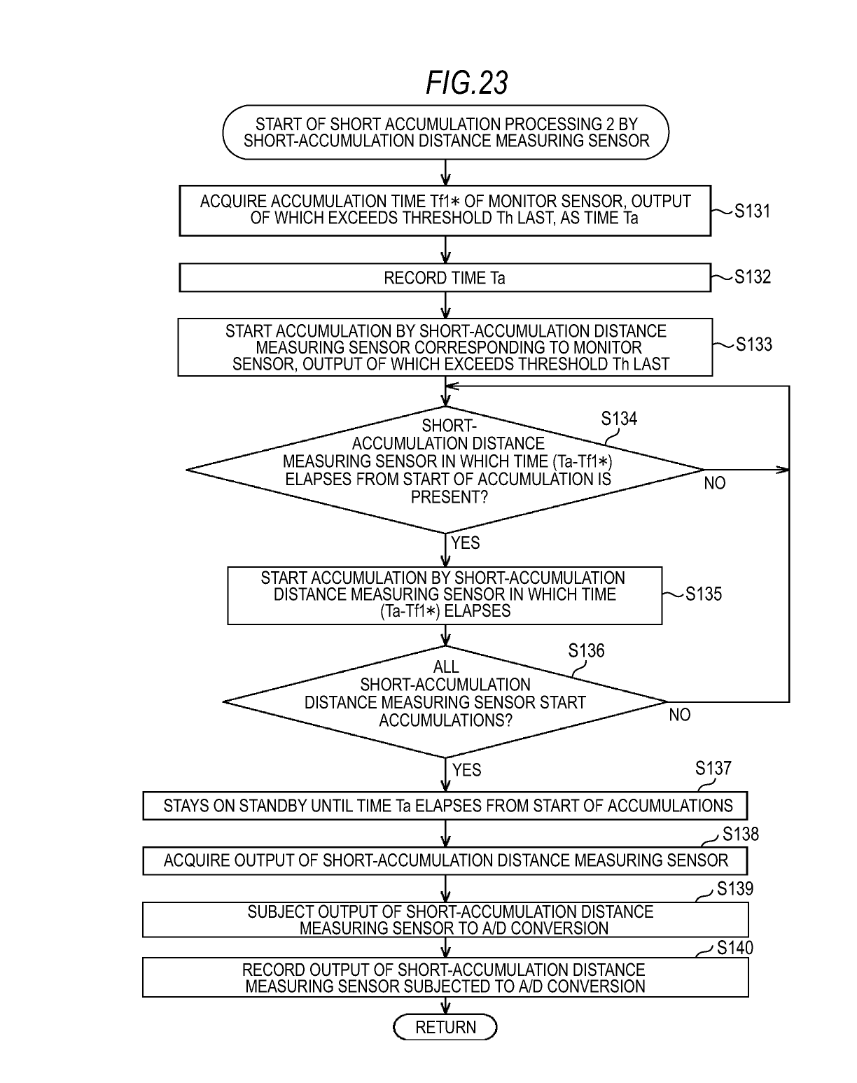

On the other hand, when the determining section 52 determines in step S106 that all the distance measuring sensor pairs 41 are short-accumulation distance measuring sensors, in step S107, the CPU 31 executes the short accumulation processing 2. The short-accumulation processing 2 by the short-accumulation distance measuring sensor is explained with reference to FIG. 23.

### [Short Accumulation Processing 2]

FIG. 23 is a flowchart for explaining the short-accumulation processing 2 by the short-accumulation distance measuring sensor.

In step S131, the acquiring section 53 acquires the accumulation time Tf1* of the monitor sensor 122, an output of which exceeds the threshold Th last, as time Ta. In the example shown in FIG. 22, the output 201I of the monitor sensor 122I exceeds the threshold Th last, an accumulation time Tf1I is acquired as the time Ta.

In step S132, the recording section 54 records the time Ta. Specifically, the acquired accumulation time Tf1I is recorded as the time Ta.

The time Ta is used instead of the time T1 shown in FIG. 17. Consequently, it is possible to reduce time (T1−Ta)×2 compared with the example shown in FIG. 17 and quickly execute the processing.

When luminance fluctuation or the like occurs within the time (T1−Ta)×2, an output could shift. However, it is possible to supply a more accurate output of the distance measuring sensor pair 41 by reducing the time (T1−Ta)×2.

In step S133, the control section 51 starts an accumulation by the short-accumulation distance measuring sensor corresponding to the monitor sensor 122, the output of which exceeds the threshold Th last. In the example shown in FIG. 22, an accumulation by a photodiode 141I of a short-accumulation distance measuring sensor I is started.

In step S134, the determining section 52 determines whether a short-accumulation distance measuring sensor in which time (Ta−Tf1*) elapses from the start of the accumulation is present. In other words, the determining section 52 determines whether a short-accumulation distance measuring sensor that starts accumulation is present.

When the determining section 52 determines in step S134 that a short-accumulation distance measuring sensor that starts accumulation is not present yet, the processing returns to step S134 and the same processing is repeated.

When the determining section 52 determines in step S134 that a short-accumulation distance measuring sensor that starts accumulation is present, in step S135, the control section 51 starts an accumulation by the short-accumulation distance measuring sensor in which the time (Ta−Tf1*) elapses.

For example, when time (Ta−Tf1H) elapses, an accumulation by a short-accumulation distance measuring sensor H is started. When time (Ta−Tf1G) elapses, an accumulation by a short-accumulation distance measuring sensor G is started.

In step S136, the determining section 52 determines whether all the short-accumulation distance measuring sensors start accumulations.

When the determining section 52 determines in step S136 that not all the short-accumulation distance measuring sensors start accumulations, i.e., when a short-accumulation distance measuring sensor that does not start accumulation is present, the processing returns to step S134 and the processing in step S134 and subsequent steps is repeated.

When the determining section 52 determines in step S136 that all the short-accumulation distance measuring sensors start accumulations, in step S137, the control section 51 stays on standby until the time Ta elapses from the start of the accumulation. In other words, the control section 51 stays on standby until the accumulations by all the short-accumulation distance measuring sensors end.

In step S138, the acquiring section 53 acquires an output of the short-accumulation distance measuring sensor. In the example shown in FIG. 22, outputs of the short-accumulation distance measuring sensors G, H, and I are acquired.

In step S139, the control section 51 subjects the output of the short-accumulation distance measuring sensor to the A/D conversion. Specifically, the control section 51 controls the A/D conversion sections 143 and subjects outputs of the photodiodes 141 to the A/D conversion using the reference voltage of the reference-signal generating section 131.

The outputs of the short-accumulation distance measuring sensors G, H, and I are supplied to the reference-signal generating section 131 at the same timing. The control section 51 subjects an output of a photodiode 141G to the A/D conversion via an A/D conversion section 143G of the short-accumulation distance measuring sensor G, i.e., a distance measuring sensor pair 41G and the reference-signal generating section 131.

Similarly, the control section 51 subjects outputs of photodiodes 141H and 141I to the A/D conversion via A/D conversion sections 143H and 143I of short-accumulation distance measuring sensors H and I, i.e., distance measuring sensor pairs 41H and 41I and the reference-signal generating section 131.

In step S140, the recording section 54 records the output of the short-accumulation distance measuring sensor subjected to the A/D conversion. Specifically, the output of the photodiode 141G is recorded in a digital memory section 144G.

Similarly, the outputs of the photodiodes 141H and 141I are respectively recorded in digital memory sections 144H and 144I. After the processing in step S140, the short accumulation processing 2 ends and the processing returns to FIG. 21.

On the other hand, when the determining section 52 determines in step S102 in FIG. 21 that the time T1 elapses, in step S108, the determining section 52 determines whether the distance measuring sensor pair 41 is the distance measuring sensor pair 41, an output of the monitor sensor 122 corresponding to which exceeds the threshold Th within the time T1.

In other words, the determining section 52 determines whether the distance measuring sensor pair 41 is a short-accumulation distance measuring sensor or a long-accumulation distance measuring sensor.

When the determining section 52 determines in step S108 that the distance measuring sensor pair 41 is a long-accumulation distance measuring sensor, in step S109, the acquiring section 53 acquires the relevant all distance measuring sensor pairs 41 as long-accumulation distance measuring sensors.

In step S110, the long accumulation processing is executed. The long accumulation processing is as explained above with reference to FIG. 18.

On the other hand, when the determining section 52 determines in step S108 that the distance measuring sensor pair 41 is a short-accumulation distance measuring sensor, in step S111, the acquiring section 53 acquires all the short-accumulation distance measuring sensors.

In step S112, the short accumulation processing 1 is executed. The short accumulation processing 1 is as explained above with reference to FIG. 19.

After the short accumulation processing 2 in step S107 and after the long accumulation processing in step S110 and the short accumulation processing in step S112, the distance measuring sensor accumulation processing 2 ends.

As explained above, when all the distance measuring sensor pairs 41 are short-accumulation distance measuring sensors, it is possible to more quickly and surely execute the accumulations by the distance measuring sensor pairs 41.

### [Others]

Embodiments of the present disclosure are not limited to the embodiment explained above. Various changes are possible without departing from the gist of the present disclosure. In the embodiment of the present disclosure, a part of the functions of an apparatus may be included in another apparatus.

The present disclosure can be implemented in the following configurations.

(1) An imaging apparatus including a control section configured to control timing for starting accumulations by photodiodes of a plurality of distance measuring sensors, wherein the control section controls the timing for starting the accumulations by the photodiodes such that the accumulations by the photodiodes of the plurality of distance measuring sensors end at the same timing.

(2) The imaging apparatus according to (1), further including, for each of the distance measuring sensors, a monitor sensor for determining an accumulation time of the photodiodes, wherein the control section controls the timing for starting the accumulations by the photodiodes on the basis of the accumulation time determined by the monitor sensor.

(3) The imaging apparatus according to (2), wherein, when an output of the monitor sensor does not exceed a predetermined threshold within a predetermined time, the control section starts accumulations by the photodiodes of the distance measuring sensors for long accumulation corresponding to the monitor sensor and controls timing for starting accumulations by the photodiodes of the plurality of distance measuring sensors for short accumulation such that timing for ending an accumulation by the distance measuring sensor for short accumulation, an output of the monitor sensor corresponding to which exceeds the predetermined threshold within the predetermined time, is time when length of time same as the predetermined time elapses from timing for starting the accumulation by the distance measuring sensor for long accumulation.

(4) The imaging apparatus according to (3), wherein, when all outputs of a plurality of the monitor sensors exceed the predetermined threshold within the predetermined time, the control section starts accumulations by the photodiodes of the distance measuring sensor, an output of the monitor sensor corresponding to which exceeds the predetermined threshold last and, when the output of the monitor sensor exceeds the predetermined threshold last, the control section controls timing for starting accumulations by the photodiodes of the other distance measuring sensors such that accumulations by the photodiodes of the other distance measuring sensors end at the same timing as an end of accumulations by the photodiodes of the distance measuring sensor, the output of the monitor sensor corresponding to which exceeds the predetermined threshold last.

(5) The imaging apparatus according to any one of (1) to (4), further including an A/D conversion section configured to convert analog signals, which are output results of the photodiodes, into digital signals, wherein the A/D conversion section converts analog signals, which are output results of the photodiodes of the plurality of distance measuring sensors, into digital signals at the same timing.

(6) The imaging apparatus according to (5), further including one reference-signal generating section, wherein the A/D conversion section converts the analog signals, which are the output results of the photodiodes, into digital signals using a reference voltage of the reference-signal generating section.

(7) The imaging apparatus according to (6), wherein the A/D conversion section converts the analog signals, which are the output results of the photodiode, into digital signals in a column ADC system using the reference voltage of the reference-signal generating section.

(8) The imaging apparatus according to any one of (5) to (7), further including a digital memory section configured to store the output results of the photodiodes converted into the digital signal by the A/D conversion section.

(9) An imaging method including controlling timing for starting accumulations by photodiodes of a plurality of distance measuring sensors, wherein the controlling the timing includes controlling the timing for starting the accumulations by the photodiodes of the plurality of distance measuring sensors such that the accumulations by the photodiodes end at the same timing.

(10) A computer-readable recording medium having stored therein a computer program for causing a computer to control timing for starting accumulations by photodiodes of a plurality of distance measuring sensors, wherein the controlling the timing includes controlling the timing for starting the accumulations by the photodiodes of the plurality of distance measuring sensors such that the accumulations by the photodiodes end at the same timing.

(11) A computer program for causing a computer to control timing for starting accumulations by photodiodes of a plurality of distance measuring sensors, wherein the controlling the timing includes controlling the timing for starting the accumulations by the photodiodes of the plurality of distance measuring sensors such that the accumulations by the photodiodes end at the same timing.

The present disclosure contains subject matter related to that disclosed in Japanese Priority Patent Application JP 2011-142967 filed in the Japan Patent Office on Jun. 28, 2011, the entire contents of which are hereby incorporated by reference.

It should be understood by those skilled in the art that various modifications, combinations, sub-combinations and alterations may occur depending on design requirements and other factors insofar as they are within the scope of the appended claims or the equivalents thereof.

What is claimed is:

1. An imaging apparatus comprising:
a control section configured to control timing for starting accumulations by photodiodes of a plurality of distance measuring sensors, wherein
the control section controls the timing for starting the accumulations by the photodiodes such that the accumulations by the photodiodes of the plurality of distance measuring sensors end at same timing.

2. The imaging apparatus according to claim 1, further comprising, for each of the distance measuring sensors, a monitor sensor for determining an accumulation time of the photodiodes, wherein
the control section controls the timing for starting the accumulations by the photodiodes on the basis of the accumulation time determined by the monitor sensor.

3. The imaging apparatus according to claim 2, wherein, when an output of the monitor sensor does not exceed a predetermined threshold within a predetermined time, the control section starts accumulations by the photodiodes of the distance measuring sensors for long accumulation corresponding to the monitor sensor and controls timing for starting accumulations by the photodiodes of the plurality of distance measuring sensors for short accumulation such that timing for ending an accumulation by the distance measuring sensor for short accumulation, an output of the monitor sensor corresponding to which exceeds the predetermined threshold within the predetermined time, is time when length of time same as the predetermined time elapses from timing for starting the accumulation by the distance measuring sensor for long accumulation.

4. The imaging apparatus according to claim 3, wherein, when all outputs of a plurality of the monitor sensors exceed the predetermined threshold within the predetermined time, the control section starts accumulations by the photodiodes of the distance measuring sensor, an output of the monitor sensor corresponding to which exceeds the predetermined threshold last and, when the output of the monitor sensor exceeds the predetermined threshold last, the control section controls timing for starting accumulations by the photodiodes of other distance measuring sensors such that accumulations by the photodiodes of the other distance measuring sensors end at same timing as an end of accumulations by the photodiodes of the distance measuring sensor, the output of the monitor sensor corresponding to which exceeds the predetermined threshold last.

5. The imaging apparatus according to claim 4, further comprising an A/D conversion section configured to convert analog signals, which are output results of the photodiodes, into digital signals, wherein
the A/D conversion section converts analog signals, which are output results of the photodiodes of a plurality of the distance measuring sensors, into digital signals at the same timing.

6. The imaging apparatus according to claim 5, further comprising one or one or more reference-signal generating sections, wherein
the A/D conversion section converts the analog signals, which are the output results of the photodiodes, into digital signals using a reference voltage of the one or one or more reference-signal generating sections.

7. The imaging apparatus according to claim 6, wherein the A/D conversion section converts the analog signals, which are the output results of the photodiode, into digital signals in a column ADC system using the reference voltage of the one or one or more reference-signal generating sections.

8. The imaging apparatus according to claim 7, further comprising a digital memory section configured to store the output results of the photodiodes converted into the digital signal by the A/D conversion section.

9. An imaging method comprising:
controlling timing for starting accumulations by photodiodes of a plurality of distance measuring sensors, wherein
the controlling the timing includes controlling the timing for starting the accumulations by the photodiodes of the plurality of distance measuring sensors such that the accumulations by the photodiodes end at the same timing.

10. A computer-readable recording medium having stored therein a computer program for causing a computer to execute controlling of timing for starting accumulations by photodiodes of a plurality of distance measuring sensors, wherein
the controlling of the timing includes controlling the timing for starting the accumulations by the photodiodes of the plurality of distance measuring sensors such that the accumulations by the photodiodes end at the same timing.

11. A computer program for causing a computer to execute controlling of timing for starting accumulations by photodiodes of a plurality of distance measuring sensors, wherein
the controlling of the timing includes controlling the timing for starting the accumulations by the photodiodes of the plurality of distance measuring sensors such that the accumulations by the photodiodes end at the same timing.
